(19) United States
(12) Patent Application Publication
(10) Pub. No.: US 2024/0119420 A1
(43) Pub. Date: Apr. 11, 2024

(54) AUTOMATED MODELING OF ONLINE JOB APPLICATIONS FOR FACILITATING JOB APPLICATION COMPLETION

(71) Applicant: Indeed, Inc., Austin, TX (US)

(72) Inventors: Dhwaj Raj, Hyderabad (IN); John Hitt, Round Rock, TX (US); Joseph Michael Barratt, Austin, TX (US); Maoyuan Yan, Austin, TX (US); Varun Prasad, Austin, TX (US)

(21) Appl. No.: 17/938,142

(22) Filed: Oct. 5, 2022

(51) Int. Cl. G06Q 10/10

(52) U.S. Cl. CPC G06Q 10/1053

(57) ABSTRACT

A system and method automatically models online job applications provides assistance to job applicants completing the job applications. Initially, as job applicants complete online job applications, their previously collected personal profile is concurrently displayed for those job applicants to select data fields from that personal profile for use in filling out specific data fields in the job applications. This selection and use of personal profile information for completing the job applications is monitored and data points are generated and stored documenting the data fields the job applicants selected from the personal profiles and the associated data fields where those selected personal profile data fields are utilized to complete job applications. Data points are generated and stored documenting the data field associations, the data points are utilized to identify associations, and the associations are stored as models to be utilized to provide assistance to other job applicants.

### BACKGROUND

### Technical Field

The present invention relates generally to automatically modeling online job applications, and more specifically to a computer implemented system and method for automatically modeling online job applications on third party websites to, for example, facilitate job application completion.

### Description of Related Art

With the advent of the internet, persons looking for employment may now seek jobs online. For example, prospective job applicants often search websites of potential employers to look for job openings. Upon finding a promising job listing, the job applicant may submit a cover letter and resume to an email address or physical mailing address cited with the job listing. Some potential employers, also referred to as job providers, may provide an online job application website for the job applicant to submit a job application. This online job application website may be generic in nature for all job openings for that employer, or it may be tailored for each job opening or selective job openings. This online job application website may include multiple operations or webpages that the job applicant may fill out and complete for submitting his or her job application. Employers may also utilize licensed third party software, such as applicant tracking systems, or third party service providers to manage such online job application webpages.

Job applications are often hosted on unique websites. Some employment service providers store job applications from multiple employers into a searchable job listing database. This job listing database may be queried online by a variety of prospective job applicants. When a prospective job applicant identifies a promising job listing in the job listing database, the job applicant may be directed through an association associated with the job listing to an online job application website. This online job application website may be provided by the job provider or by a third party on behalf of the job provider. The job applications are generally different at a fundamental data collection level, such as having unique, unpopulated data fields. For example, job applications may request the same type of data, but the identifier used to request the data may be different. For example, one job application may request a “home address” while another requests a “residency address.” One job application may request “prior work history” while another requests “past employment,” and so on. This is a relatively simple task for a human to adapt to but not for a machine. As mentioned, some websites have attempted to reduce this time-consuming manual process of locating multiple job applications by publishing links to the multiple job applications, which allows the job applicant to locate job applications faster. However, completion of each non-uniform, unique job application is still time-consuming and technically challenging for a machine.

### SUMMARY

In one embodiment, a method of modeling and enabling a data processing system to automatically complete an online job application on a third party website. In another embodiment, a job application management system includes one or more processors and a memory, coupled to the one or more processors, having code stored therein for modeling and enabling a data processing system to automatically complete an online job application on a third party website, wherein the code is executable by the one or more processors to cause the one or more processors to perform the operations. In a further embodiment, a non-transitory, computer readable medium having code stored therein for modeling and enabling a data processing system to automatically complete an online job application on a third party website, wherein the code is executable by one or more processors to cause the one or more processors to perform the operations.

The operations include accessing online registration information from a set of first job applicants, a personal profile each job applicant in the set of job applicants, associations to online job applications on one or more third party websites that displayed personal profiles of the job applicants, and data entries by the job applicants for selected data fields of the personal profile. The operations further include generating and storing a set of data points associating the selected data fields of the personal profile to the identified data fields of the online job application and utilizing the set of stored data points to generate a model of the online job application, the model including nodes correlating data fields of the personal profile to the data fields of the online job application. The operations also include receiving an online registration of a second job applicant and responsive to the online registration of a second job applicant, obtaining a second personal profile of the second job applicant. The operations additionally include receiving a second online query from the second job applicant, responsive to the second online query from the second job applicant, providing association to the online job application on the third party website, and utilizing the model of the online job application, providing recommended data fields of the second personal profile to the second job applicant for completing identified data fields of the online job application.

### BRIEF DESCRIPTION OF THE DRAWINGS

The following figures illustrate aspects of the system and method for automatically modeling online job applications and are subsequently discussed in more detail.

FIG. 1 depicts a block diagram of a job application management system for modeling online job applications on third party websites and for utilizing such models to assist a job applicant in completing online job applications.

FIGS. 2A-2B depict flow diagrams of the job application management system modeling online job applications on third party websites.

FIGS. 3A-3B depict diagrams of a user interface page utilized for identifying available jobs for a job applicant.

FIGS. 4A-4B depict diagrams of a user interface page utilized for monitoring a job applicant completing a job application on a third party website towards generating a job application model of that job application.

FIGS. 5A-5B depict diagrams of a user interface page utilizing the generated job application model to assist a job applicant in completing a job application on a third party website

FIG. 6 depicts a flow diagram of the user interface monitoring a job applicant completing a job application on a third party website towards generating a job application model of that job application.

FIG. 7 depicts a flow diagram 700 of the job application management system generating a model of a third party job application.

FIG. 8 depicts a flow diagram 800 of the job application management system utilizing models for assisting a job applicant in completing an online job application.

FIG. 9 depicts a block diagram of an illustrative data processing system.

FIG. 10 depicts a block diagram of an illustrative network of data processing systems.

### DETAILED DESCRIPTION

An automatic modeling online job applications system and method utilizes processes and devices to automatically model online job applications on third party websites to facilitate job application completion. Embodiments of the system and method may be implemented and utilized as will be explained with reference to the various embodiments below.

As discussed above, job applicants often apply to jobs by completing a specific and unique job application for each job opportunity, which is time-consuming. The job applications are often posted on multiple web sites, and the job application formats, content, order of completion, and other characteristics are non-uniform from job application-to-job application and from website-to-website. Human job applicants adapt to the non-uniform disparities of different job applications by, for example, reading the job application, intuitively processing the data fields in the job application and understanding what data is requested, and correctly entering data requested by the job application. However, adapting to non-uniform characteristics of unique job applications is not a rote, replicable task of the type normally performed automatically by a machine, such as a data processing system. Such lack of adaptive ability presents a non-trivial technical hurdle for machines. Machines do not process information like humans and, thus, do not conventionally adapt to, for example, variations and non-uniform input and output characteristics of job applications.

Embodiments of the automatic modeling online job applications system and method technically improve machine functionality by enabling machines to overcome such technical hurdle using models that allow the machines to recognize disparate, non-uniform data fields across multiple job applications, associate the data fields with job applicant data, access the correlated data, and automatically populate the data fields. Not only does the automatic modeling online job applications system and method technically improve machine functionality, the system and method improve productivity of the user by reducing time-consuming tasks with new technology and without simply relying on faster data processing capabilities of data processing systems. Embodiments of the automatic modeling online job applications system and method also generate the models that are applied to overcome conventional, technical limitations of machines. A further technological advancement allows the automatic modeling online job applications system and method to utilize the model to remotely and automatically complete a job application hosted by a third party website.

In at least one embodiment, the automatic modeling online job applications system and method provide assistance to job applicants completing the job applications. Initially, as job applicants are completing online job applications, the system and method concurrently displays their previously collected personal profile for those job applicants to select data fields from that personal profile for use in filling out specific data fields in the job applications. In at least one embodiment, job applicant data is stored in the personal profile for each job applicant. The personal profile associates particular data field identifiers with particular data. For example, the job applicant profile may associate a home street address identifier HSADDR with the job applicant's home street address, associate a mobile phone identifier MPHONE with the job applicant's mobile phone number, and so on. The selection and use of personal profile information for completing the job applications is monitored and data points are generated and stored. The data points document the data fields the job applicants selected from the personal profiles and the associated data fields where those selected personal profile data fields are utilized to complete job applications. In at least one embodiment, the automatic modeling online job applications system and method logs associations between job applicants' interaction and data fields in online job application web page source code elements, such as a hyper text markup language (HTML) element. For example, if the source code HTML element identifies a particular field as a “HSADDR” and the job applicant inserts the job applicant's home street address into the field, then the automatic modeling online job applications system and method associates HSADDR to the particular web page and to a home address. This modeling process is repeated for other online job application web pages. In at least one embodiment, the model stores the associations as nodes and edges that identify and track which data fields in personal profiles are utilized to complete identified data fields in the job applications. When a job applicant accesses a job application web page that has been modeled, the system and method utilize the associations to autopopulate the online job application.

In at least one embodiment, the system and method utilize machine learning to learn which data fields associate with which job applicant data for each identified job application web page. The system and method feed the personal profile fields, job application data field identifiers (such as HTML elements), and web page identifier associations into a machine learning model that learns the associations over time and can make inferences based on variations in different job application identifiers. Thus, when sufficiently trained, the machine learning model can complete job applications from third party websites that were not part of the training process. In at least one embodiment, the model is sufficiently trained when the model reaches a satisfactory statistical confidence level, and the satisfactory statistical confidence level is a matter of design choice, such as a value between 90% and 99%. Thus, once the models are generated, the models may then be utilized to provide assistance to other job applicants by providing suggested personal profile information for completing portions of a modeled online third party job application.

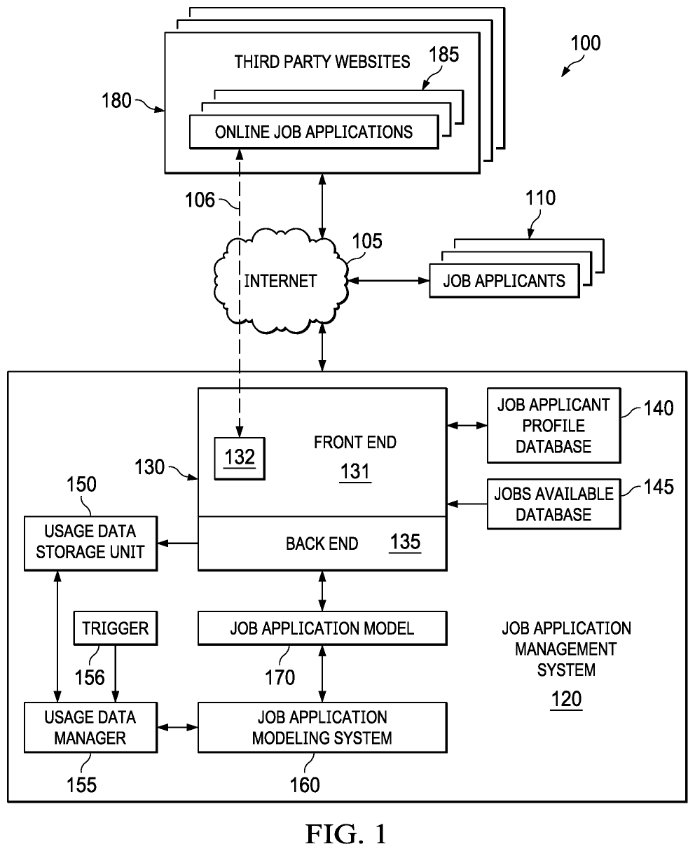

FIG. 1 depicts a system for automatically modeling online job applications 100 and includes a job application management system 120 utilized for modeling online job applications 185 on third party websites 180 and for utilizing such models to assist job applicants 110 in completing online job applications 185. Job applicants are collectively and individually referred to as job applicants 110 or job applicant 110. Various embodiments describing the operation of the system for automatically modeling online job applications 100 are provided below.

Job application management system 120 communicates with job applicants 110 and third party websites 180 across internet 105. Job application management system 120 provides associations 106 for job applicant 110 to complete job applications. As described in greater detail below, job applicants 110 seeking employment may communicate with job application management system 120 across one or more communication channels, such as internet 105. In response to queries from job applicants 110, job application management system 120 provides associations 106 across internet 105 to potential jobs and associated online job applications 185 on third party websites 185. Furthermore, job application management system 120 may monitor job applicants 110 completing job applications 185 through associations 106 towards modeling those online job applications and subsequently assisting job applicants 110 in completing online job applications 185.

Third party websites 180 are websites managed or otherwise controlled by entities other than an entity that manages or otherwise controls job application management system 120. Each third party website 180 may have one or multiple online job applications, each online job application associated with potentially available jobs. Third party websites 180 and online job applications 185 thereon may be modified with limited notification of those modifications to job application management system 120. For example, third party websites 180 or the entities managing those websites may provide notification of available jobs and an internet address of associated job applications 185 to job application management system 120. However, the information provided may not include details of how the online job applications are to be filled in and completed by job applicants 110. As a result, job applicant management system 120 may model online job applications 185 on third party websites 180 as described below towards assisting job applicants 110 in completing those job applications.

Job application management system 120 may include a user interface 130, job applicant profile database 140, job application usage data storage unit 150, usage data manager 155 including trigger 156, job application modeling system 160 and job application model 170. User interface 130 may include a front end 131, data association manager 132 and a backend 135. Front end 131 provides an online user experience for job applicants 110, including registration of the job applicants, obtaining user profiles from those job applicants, and providing a list of available jobs from jobs available database 145 in response to job applicant queries. For each of job applicants 110, upon a job applicant selecting an available job from jobs available database, front end user interface 131 may provide association 106 to an associated online job application 185 on a third party website through or otherwise directed by data association manager 132. Data association manager 132 may be a set of JavaScript or a browser plug-in such as described in greater detail below. Data association manager 132 may monitor and assist the job applicant 110 as the job applicant completes a linked job application 185 on third party websites 180. While the job applicant 110 fills in and completes job application 185, data association manager 132 may also gather usage data of that process, which is then stored by backend 135 in job application usage data storage unit 150. Upon a condition or event, trigger 156 initiates usage data manager 155 to feed selected usage data from storage unit 150 to job application modeling system 160 for modeling online job applications 185. A triggering condition or event is, for example, reaching a threshold, which is subsequently described in more detail. Usage data manager may also remove, inactivate, or otherwise avoid utilizing usage data from storage unit 150 that may be outdated, whether by age or by contrary usage data that is more recent. Job applicant modeling system generates, updates, and stores job application model 170 of online job applications 185.170. As described in greater detail below, the job application system 120 utilizes the job application model 170 for enabling user interface 130 to assist job applicants 110 in completing online job applications 185.

In at least one embodiment, the job application model generates job application model 170 to model associations between job applicant personal profile data fields, online job application data fields in web pages of job applications 180, and the third party websites 180, which are the sources of the online job applications. To create the job application model 170, in at least one embodiment, the job application modeling system 160 logs a job applicant's interaction with a third party job application 185. In at least one embodiment, the third party job application 185 is in a markup language, such as HTML. The HTML version of the job application 185 has specific elements such as ID's, class names, etc. for data fields in the job application 185. The job applicant's personal profile has “profile fields,” e.g. Address, Education, Experience, etc. When a job applicant selects a specific profile field to complete an HTML data field identified by a specific element, a logging program of the job application management system 120 logs the association between the selected profile field and the HTML element. For example, the job applicant selects “Home Address” for the “ADDR” element in the HTML based job application. Thus, the model associates “Home Address” with “ADDR.” HTML elements for the same information can have a variety of element identifiers across different job applications 185. For example, an HTML element corresponding to a personal profile field of Home Address could be “ADDR” in one job application, “ADR,” “HA,” “HADDR,” “HADD,” etc. or something far less descriptive, such as an alphanumeric identifier “134,” “N48A,” etc. in other job applications.

In at least one embodiment, the job application modeling system 160 includes machine learning technology, and the job application model 170 is a machine learning model. To train the job application model 170 to infer associations between a job applicant's personal profile, an online job application 185, and a third party job application web site 180, the job application modeling system 1060 feeds the associations into the job application model 170 to learn the associations over time. When adequately trained, the job application model allows machine learning engine of the job application management system 120 to make inferences based on close variations in different HTML elements. Thus, when sufficiently trained, the machine learning model can complete job applications from 3rd party websites that were not part of the training process. In at least one embodiment, the job application model 170 is sufficiently trained when the model reaches a satisfactory statistical confidence level, and the satisfactory statistical confidence level is a matter of design choice, such as a value between 90% and 99%.

As may be appreciate by one of ordinary skill in the art, alternative embodiments may utilize different configurations to implement the elements and functions of the job application management system. For example, multiple modeling systems may be utilized in parallel to develop models or other data structures for assisting job applicants in completing online job applications. Further embodiments and alternatives thereto are disclosed below with reference to associated Figures.

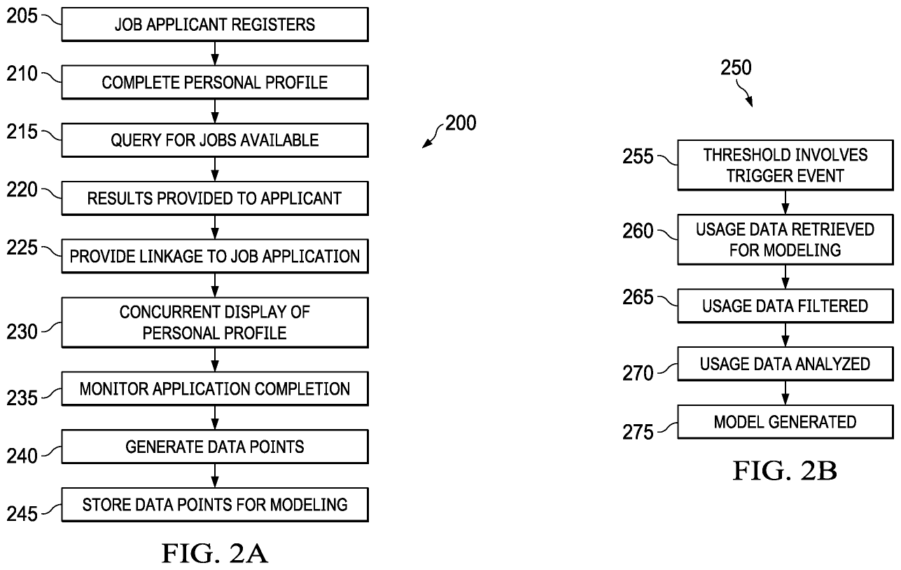

FIGS. 2A-2B depict flow diagrams of job application management system 120 modeling online job applications 185 on third party websites 180, in which various embodiments of the present disclosure may be implemented. FIGS. 2A-2B are described with reference to the job application management system 120 of FIG. 1 as well as with the user interface described with reference to the below described Figures. In at least one embodiment, the following may be performed for all third party job application websites accessible through the job application management system, although it may be limited to certain job application websites based on prior experience or other factors.

FIG. 2A depicts a flow diagram 200 of job application management system 120 generating usage data 150 linking job applicant profile data fields with job application website data fields. In a first operation 205, a job applicant 110 may register with job application management system 120 in an online session on user interface 130. That is, the job applicant may register and log into the user interface 130 run by the job application management system 120 through an online website across internet 105. This may include obtaining a unique job applicant identifier, developing a corresponding password, and logging onto the job applicant management system utilizing the unique job applicant identifier and corresponding password. Additional secondary authentication of the job applicant may also be utilized. Then in operation 210, job applicant 110 may complete a job applicant profile database 140 with user interface 130 in the online session. This personal profile may include information suitable for use in completing job applications such as name, address, education, prior job experience, job references, etc. Alternatively, such information may be gleaned by the job application management system 120 when the job applicant is completing job applications such as described below. Additional information may also be included in the job applicant profile including information useful for identifying jobs suitable and/or desirable to the job applicant.

Subsequently, in operation 215, job applicant 110 may query a jobs available database 145 through user interface 130, in the same or different online session as operations 205 and 210, for available jobs that meet certain criteria. The query criteria may be set forth by the job applicant, derived from job applicant profile database 140, or from other sources, alone or in combination with each other. Jobs available database 145 may include a set of records describing available jobs identified by potential employers or by third parties on behalf of potential employers. The jobs available database 145 may be developed in a separate process by the jobs application management system 120, such as may be known by those of ordinary skill in the art.

In operation 220, job application management system 120 provides a set of available jobs from jobs available database 145 to job applicant 110 in response to the query in operation 215. Each of the set of available jobs may include information describing the job, qualification requirements of the job including education and experience, and other relevant information. Some of the available jobs may include association to an online job application on a third party website 180 where a job applicant may complete an online job application for that job. That is, the online third party website 180 may be a website outside of job application management system 120 and not controlled by or managed by the job application management system. Such an online third party website 180 may a website, webpage, or set of webpages managed directly by the job provider or managed indirectly such as through a commercially available website licensed or otherwise utilized by the job provider for obtaining job applications from potential job applicants. Such online third party websites 180 may differ significantly from each other in the operations and information needed for a job applicant to complete job application 185. Such online job applications 185 may also change over time for a given third party website 180, whether for different available jobs or even for the same available job. As a result, modeling of such online job applications 185 on third party websites 180 may need to be continuously updated as various job applicants 110 complete those job applications.

In operation 225, responsive to job applicant 110 selecting a link, such as a uniform resource locator (URL) link, to an online job application 185, the job applicant's online session is directed through data association manager 132 to third party website 180 associated with online job application. In the case of the job applicant utilizing a mobile device for querying jobs available database 145, the job applicant may be directed through data association manager 132 to the associated third party website 180 through a local browser or other portal that is hosted or otherwise monitored by data association manager 132. For example, some JavaScript may be provided by data association manager 132 to the third party job application website 180 to monitor and assist the job applicant during the job application process. In the case or the job applicant utilizing a desktop or other non-mobile device, a monitoring plug-in may be provided by data association manager 132 to the non-mobile device browser for implementation on that device, which allows the job application management system to monitor and assist with the job application process on the third party website. That is, responsive to the job applicant selecting the online job application association in the query results, user interface 130 provides to the job applicant online access to the associated third party job application website 180 while maintaining sufficient access to monitor and assist the job applicant in completing online job application 185.

In operation 230, the job application management system 120 provides an interactive copy of the job applicant's profile for display concurrently with the third party job application website. An example of this is described below with reference to the below described Figures. That is, the job applicant 110 is able to view as well as select various fields of the displayed job applicant profile for entering into selected fields of the third party job application website. The job applicant's profile may be displayed as a type of keyboard overlaying a displayed keyboard, such as over a displayed keyboard on a mobile device, which the user may then scroll and select for entry into a selected job application field. Alternatively, the job applicant's profile may be displayed in a pop-up box, in a separate concurrently displayed window, in a toggled display, or other display type that allows the job applicant to view his or her personal profile as well as copy or click selected fields from the personal profile to fill selected fields on the online job application.

Then in operation 235, the job application management system 120 monitors the job applicant selecting data from his or her personal profile to fill certain fields in the third party job application. For example, if the job applicant selects data from a “prior experience start date” field for filling an identified field on the job application, then that movement of data is detected. Detecting movement of such data may be by detecting a copy and paste, a click and point, or other known ways for selecting and filling or otherwise moving data from one webpage document to another. Other types of data entry by the job applicant may also be detected such as the job applicant selecting a “next” button on the job application. That is, a job application may include multiple pages that need to be processed and completed by the job applicant, so such data entry of these operations may also be detected.

Then in operation 240, responsive to detecting the movement of data from a personal profile to a third party job application as described in operation 235, data association manager 132 automatically generates a data point identifying the data association between each field selected from the personal profile and the associated field selected from the third party job application. That is, each time a job applicant selects data from a first field from his or her personal profile to fill in a second field in the third party job application, a data point is generated identifying the data association between the first data field of the personal profile to the second data field of the third party job application. The underlying data being selected and filled may not be included in the data point, just identification of the data fields, so as to avoid propagating personal data and preserving user privacy. Data association manager 132 may automatically generate additional data points that identify other job applicant data actions that do not include moving data from the personal profile to the third party job application. For example, if a user clicks a “next” button on the third party job application, a data point may be generated identifying that action taken with the job application field selected by the job applicant on the third party job application.

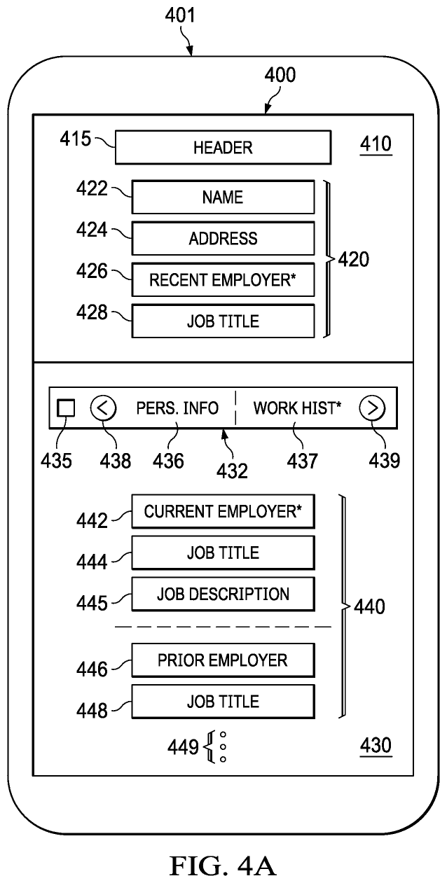

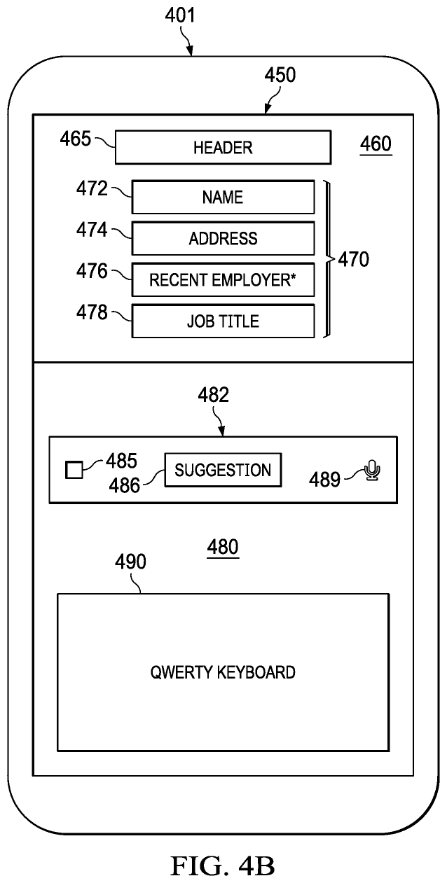

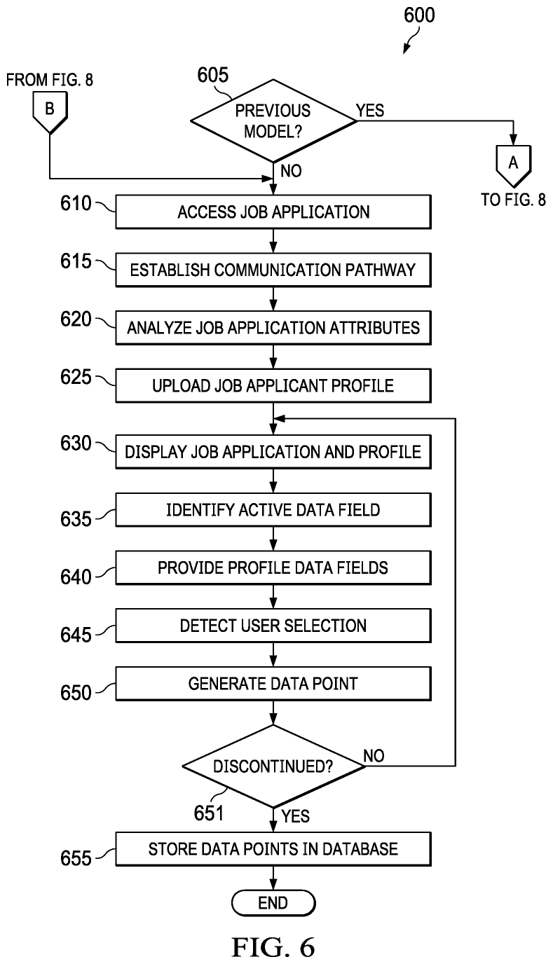

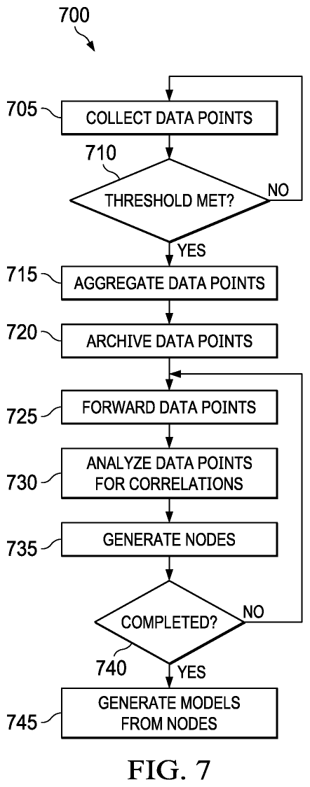

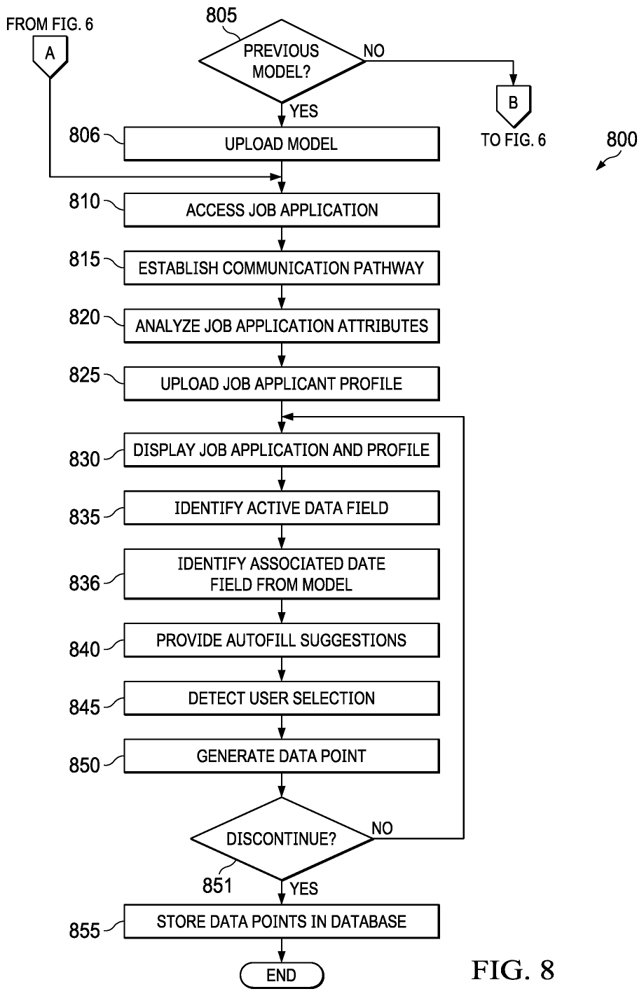

Then in operation 245, data association manager 132 stores the data points in a usage data storage unit 150 with timing information and associated contextual information such as the third party job application URL (uniform resource locator) and type of licensed software utilized by the third party job application website. This includes storing the data association data points and the action taken data points along with the contextual information with timing information. This storage of data points, contextual information and timing information may be stored as the job applicant is completing the online job application or upon completion of that online job application. The timing information may be the date and time the job applicant utilizes a third party job application website. This timing information may be retained for use in determining whether the associated data points and contextual information are potentially out of date and no longer useful or just older than other more recently gathered usage data. An example of operations 235-245 are described in greater detail below with reference to FIGS. 4A-4B and FIG. 6.

Operations 205-245 may be repeated for multiple job applicants utilizing the job application management system user interface 130 for applying for multiple jobs across multiple third party job application websites. As a result, usage data storage unit 150 may contain many data points and associated contextual information identifying associations between personal profile data fields and third party job application website data fields for multiple job applicants and multiple third party job application websites. Once a threshold amount of data has been collected in the usage data storage unit, in total or in sufficient numbers for a given third party job application website, the processing operations of FIG. 2B may be triggered to generate or update models of online job applications 185 on third party job application websites 180.

FIG. 2B depicts a flow diagram 250 of a job application management system 120 utilizing job application usage data 150, which links job applicant profile data fields with online job application data fields, to generate job application model 170 of online job applications 185 on third party job application websites 180 which may then be utilized for assisting a job applicant 110 in completing an online job application. In a first operation 255, a threshold may be met causing trigger 156 to initiate a trigger event, which initiates a process of generating models of online job applications 185. The threshold may be a timing threshold, an overall usage data threshold, a third party job application website usage data threshold, or other threshold. The timing threshold may be a periodic threshold such as hourly or daily. The overall usage data threshold may be a count or other measure of new overall usage data since the last trigger event. The online job application usage data threshold may be count or other measure of new usage data for a given third party job application website since the last trigger event for that third party website (which may trigger modeling of that website specifically). Other thresholds may be utilized, alone or in combination, to trigger the modeling of specific or all online job applications or third party job application websites as described in the following operations.

In operation 260, in response to the trigger event generated by trigger 156, usage data manager 155 retrieves usage data from job application usage data storage unit 150. This data may be retrieved by online job application, by third party website, or altogether for forwarding to job application modeling system 160. This retrieval may depend on the type of modeling system utilized, the type of job application software utilized by each third party website, or other factors such a frequency of usage of a given set of job applications. In the present embodiment, the usage data may be retrieved by online job application. Then in operation 265, usage data manager 155 may screen or perform any other filtering operation of the usage data for a given job application and forwarded to job application modeling system 160. Selected usage data, such as outdated usage data, may be inactivated or deleted and removed by job application usage data storage unit 150 by usage data manager 155 and not forwarded to job application modeling system 160. Outdated usage data may be data that is older than a predetermined threshold, the oldest data when there is a significant amount of data, or other thresholds.

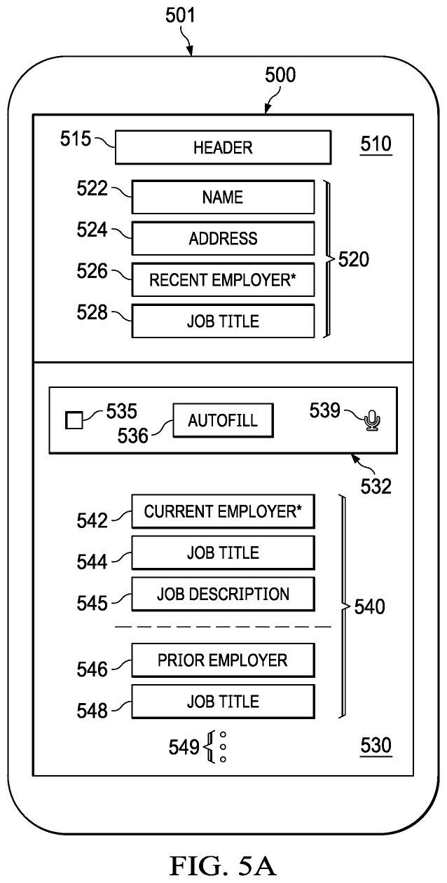

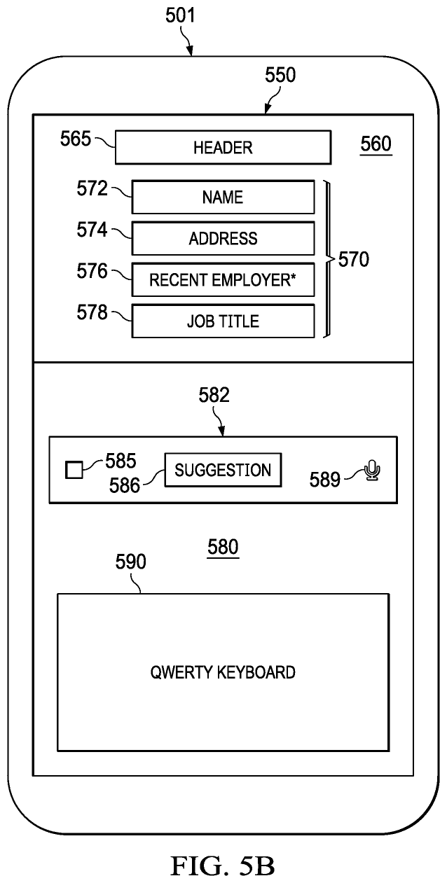

In operation 270, job application modeling system 160 reviews the forwarded usage data for analysis to identify associations between personal profile data fields and third party job application website data fields. That is, identifying where job applicants consistently select data from a given field of their personal profile to complete a certain field in the online job application. This identification of associations may be accomplished through the use of statistical analysis, through the use of the machine learning, or through the use of other techniques and tools known to those of ordinary skill in the art. Upon finding associations meeting a threshold level of confidence, in operation 275, the job application system 160 trains the job application model 170 of the online job application to associate the job applicant profile, job application 185, and third party websites 180 in the job application model 170. The job application model 170 may include a set of nodes for each online job application, each node identifying a correlation between one field of the personal profile and another field of the online job application. These nodes allow user interface 130 to provide assistance to future job applicants 110 completing online job applications as described below with reference to FIGS. 5A-5B and 8.

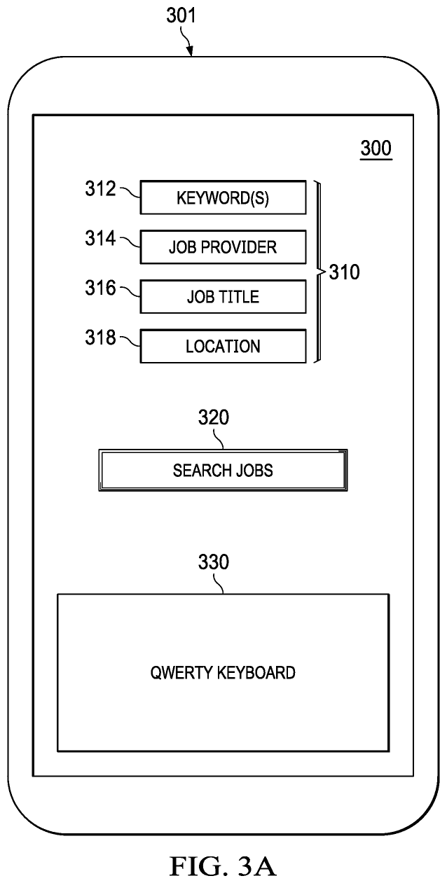

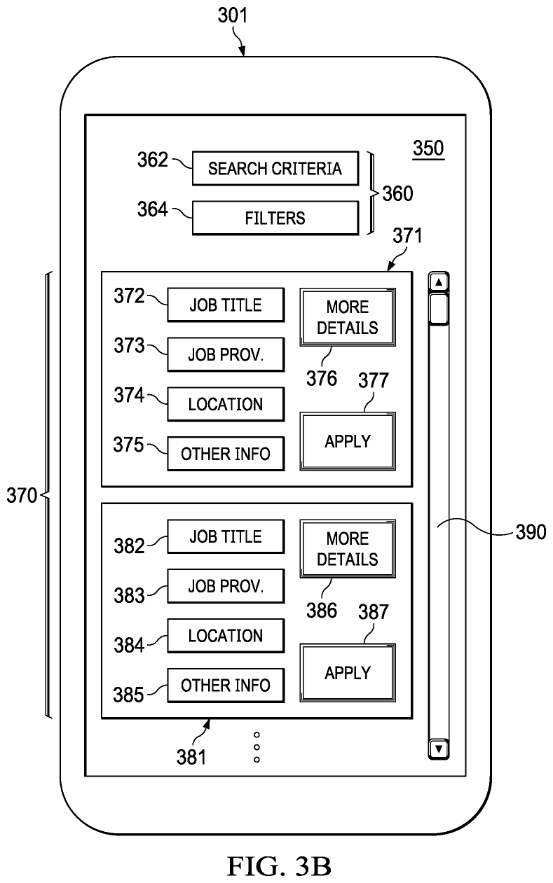

FIGS. 3A-3B, 4A-4B and 5A-5B depict diagrams of user interface pages utilized for identifying available jobs for a job applicant, for monitoring a job applicant completing a job application towards generating a job application model of that job application, and for utilizing the generated job application model to assist a job applicant in completing a job application, in which various embodiments of the present disclosure may be implemented. These diagrams are examples of user interface pages as displayed on a mobile phone but may be implemented on a variety of user devices for use by job applicants. As may be appreciated by one of ordinary skill in the art, alternative user interfaces and formats thereof may be utilized for assisting job applicants in identifying available jobs and in completing job applications.

FIGS. 3A-3B depict diagrams of a user interface page utilized for identifying available jobs for a job applicant, in which various embodiments of the present disclosure may be implemented. User interface pages 300 and 350 may be the same user interface page shown at different points in time. User interface pages 300 and 350 may be displayed on a mobile phone 301 or other user device. User interface page 300 may include a set of search fields 310 for providing criteria for a job search. Search fields 310 may be filled in manually utilizing a screen typewriter such as a QWERTY keyboard 330, selected from a pull-down menu by sliding to and tapping a desired choice on a touch screen, moving a mouse curser over one of the search fields, a combination of manual entry fields and pull-down menus, or other types of user interactions. Search fields 310 may include criteria such as keyword(s) 312, job provider 314 (e.g., a company or other entity job provider), job title 316 and location 318. Keyword(s) 310 may be utilized by the job applicant to provide certain keywords likely to be included in a job description or other elements of an available job record in a jobs available database. Job provider 314 may be utilized by the job applicant to identify a particular employer of interest. Job title 316 may be utilized by the job applicant to identify a particular type of job of interest. Location 318 may be utilized by the job application to identify a work location of interest. Location 318 could include choices such a “remote working from home”, a particular city or community, a region of a country, etc. Additional or different search fields may be utilized such as a salary range, industry type, health benefits, etc. Upon completing or modifying the search fields, the job applicant may click or otherwise select search button 320 to invoke a job search of available jobs based on the criteria set forth by the job applicant in the search fields. Alternatively, as the job applicant enters information in the search fields, concurrent searching of available jobs may be performed without necessitating selection of a search button.

Upon the job applicant selecting search button 320, or upon other conditions invoking a search operation, a search of available jobs from the jobs available database may be invoked. This job search may include the criteria set forth by the job applicant. This job search may also take into account the personal profile of the job applicant or other information which may be relevant such as prior searches by the job applicant. The search results may then be ranked or otherwise ordered for display to the job applicant as shown in user interface page 350. This ranking or otherwise ordering of the available jobs may utilize a measure of each job meeting the criteria as well as other factors such as the job applicant's qualifications or other personal profile information or prior searches by the job applicant.

User interface page 350, also referred to herein as job search results page 350, may include a header 360, a set of available jobs 370 and navigation tools 390. Header 360 may include search criteria 362 utilized to search for available jobs and additional filters 364 for narrowing the search results. Search criteria 362 may include the search criteria set forth by the job applicant in search fields 310 as described above. Search criteria 362 may include additional search criteria which may be included through an analysis of the job applicant's personal profile, prior job searches or other sources. Filters 364 may include a variety of possible filters the job applicant can select for further narrowing the displayed job search results. Examples of filters may include showing only available jobs that are full-time, within a certain distance from a certain community, etc. These filters may be selectable from a pull-down menu or other user interface mechanism for the job applicant to provide desired available job filtration. The set of available jobs 370, also referred to as job search results, may include an ordered set of available jobs 371 and 381. Each job search result may include information regarding a job such as a job title 372 and 382, a job provider 373 and 383, a location 374 and 384 and other general information 375 and 385. Other general information 375 and 385 may depend on the search criteria utilized to obtain the search results. In addition, a selectable button 376 and 386 may be provided for the job applicant user to finger tap, mouse click or otherwise select for obtaining additional information regarding the available job, such as a detailed job description, educational qualifications, etc. Furthermore, a selectable button 377 and 387 may be provided for the job application to finger tap, mouse click or otherwise select in order to apply for that available job. Upon selection of selectable button 377, the job applicant may be redirected to a set of job application pages such as shown below with reference to FIGS. 4A-4B and 5A-5B. Also included on job search results page 350 are navigation tools 390. In this embodiment, a scroll bar is shown to allow the job applicant user to scroll down or up through many more available jobs. Alternative embodiments may utilize other types of navigation tools such as may be known to those of ordinary skill in the art. As may also be appreciated by those of ordinary skill in the art, alternative embodiments may also include other types of information and formatting than the embodiment described herein.

FIGS. 4A-4B depict diagrams of a user interface page utilized for monitoring a job applicant completing a job application on a third party website towards generating a job application model of that job application, in which various embodiments of the present disclosure may be implemented. This job application on a third party website, including user interface pages 400 and 450, may have been invoked by the job applicant selecting apply button 377 or 387 described above with reference to FIG. 3B. User interface pages 400 and 450 may be the same user interface page shown at different points in time and in different modes, including a copy and paste mode and a manual entry mode, which are described in greater detail below. User interface pages 400 and 450 may be displayed on a mobile phone 401 or other user device. User interface pages 400 and 450 may include two primary components, a third party website hosted job application user interface 410 and 460, also referred to herein as third party user interface 410 and 460, as well as a job application monitoring user interface 430 and 480, also referred to herein as monitoring user interface 430 and 480. That is, pages 400 and 450 may include two concurrently displayed and interacting user interfaces as described in greater detail below.

In FIG. 4A, user interface page 400 may include third party user interface 410 and monitoring user interface 430 whereby the monitoring user interface is in a copy and paste mode. That is, the user may select a data field from monitoring user interface 430 for filling a data field in third party user interface 410 as described herein. Third party website hosted job application user interface 410 may include multiple pages or a single scrolled page of a job application to be completed online by a job applicant. Third party user interface 410 may vary significantly by the third party website hosting the job application. That is, different job providers may utilize different job applications and a single job provider may utilize different job applications for different available jobs or job types. As a result, monitoring job applicants completing these variations of job application user interfaces may allow modeling of those variations for use in assisting job applicants in completing job applications across multiple third party websites as shown with reference to FIGS. 5A and 5B below.

Third party user interface 410 may include a header 415 and a body 420. Header 415 may include identifying information regarding the job provider, the available job, the job location, and other identifying information to allow the job applicant to confirm that he or she is completing the correct job application. Body 420 may include specific fields for completion by the job application. The present example includes job applicant name 422, job application address 424, most recent employer 426 and accompanying job title 428. Additional job application fields may be provided for completion by the job applicant through scrolling or other methods of modifying user interface page 410. Recent employer 426 is shown with an asterisk to indicate that this field has been clicked on or otherwise selected for completion by the job applicant.

Monitoring user interface 430 may include association to personal profile information of the job applicant for use in completing the job applications displayed in third party user interface 410. That is, monitoring user interface 430 may provide easy job applicant access to that applicant's personal profile information to allow for rapid selective movement of that personal profile information to selected fields in third party user interface 410. Monitoring user interface 430 may include a scroll slider 432 and a body 440. Scroll slider 432, also referred to herein as an accessory bar, may include mode toggle 435 as well as various categories of information for selection by the job application such as personal information 436 (e.g., name, address, etc.) and work history 437. Additional categories of information may be displayed by selecting arrows 438 or 439. Mode toggle 435 may be an icon, which when selected may move the monitoring user interface from the copy and paste mode of monitoring user interface 430 to the manual entry mode of monitoring user interface 480. Work history 437 is shown with an asterisk to indicate that this information category has been clicked on or otherwise selected by the job applicant to indicate that information to be displayed below in body 440. Body 440 may include specific fields for selection by the job applicant for use in completing the job application as indicated by the information category selected above. The present example includes current employer 442, job title 444, job description 445, prior employer 446, prior job title 448 and additional work history fields 449. Additional work history fields 449 may be provided for completion by the job applicant through scrolling or other methods of modifying monitoring user interface page 460. Current employer 442 is shown with an asterisk to indicate that this field has been clicked on or otherwise selected for use in completing the job application in third party user interface 410.

In operation, a job applicant may be presented third party user interface 410 with job applicant name 422, job application address 424, most recent employer 426 and accompanying job title 428 as shown. Most recent employer 426 may be highlighted by the third party user interface to show that it is the next data field to be filled in by the job applicant. This highlighting of the most recent employer data field may be performed automatically by third party user interface 410 or upon a selection by the job applicant such as by a finger tap or mouse click. The job applicant may then use scroll slider 432 to show work history 437. Upon selecting work history 437, which may highlight that selection, body 440 may be shown with current employer 442, job title 444, job description 445, prior employer 446 and prior job title 448. The job applicant may then select current employer 442, which highlights that field. The information in current employer 442 may then be copied and pasted into most recent employer 426, either automatically by the monitoring user interface or by the user subsequently selecting most recent employer 426. In either case, the data in current employer 442 from the job applicant's personal profile may be provided by monitoring user interface 430 to third party user interface 410 for filling in most recent employer 426. In addition, a record or other data representation may be generated that documents the association of current employer 442 with most recent employer 426. For privacy purposes, this record may not include any specific information from the user's personal profile, just an association of the job applicant's current employer 442 data field with most recent employer 476 data field. This record may then be stored in a database of data field associations for use in modeling the third party job application as described in greater detail herein.

In FIG. 4B, user interface page 450 may include third party user interface 460 and monitoring user interface 480 whereby the monitoring user interface is in a manual entry mode. That is, the user may manually enter data into a selected data field from third party user interface 460 as described herein. For example, monitoring user interface 480 may include a QWERTY keyboard for manual typing of data for entry into a data field in third party user interface 460. The job applicant may toggle between the copy and paste mode of monitoring user interface 430 and the manual entry mode of monitoring user interface 480 by clicking on certain icons, by pressing certain control characters on a keyboard of the user device, double tapping on a touch screen, or other predesignated signal.

Third party website hosted job application user interface 460 may include multiple pages or a single scrolled page of a job application to be completed online by a job applicant. Third party user interface 460 may vary significantly by the third party website hosting the job application. That is, different job providers may utilize different job applications and a single job provider may utilize different job applications for different available jobs or job types. As a result, monitoring job applicants completing these variations of job application user interfaces may allow modeling of those variations for use in assisting job applicants in completing job applications across multiple third party websites as shown with reference to FIGS. 5A and 5B below.

Third party user interface 460 may include a header 465 and a body 470. Header 465 may include identifying information regarding the job provider, the available job, the job location, and other identifying information to allow the job applicant to confirm that he or she is completing the correct job application. Body 470 may include specific fields for completion by the job application. Similar to FIG. 4A, the present example includes job applicant name 472, job application address 474, most recent employer 476 and accompanying job title 478. Additional job application fields may be provided for completion by the job applicant through scrolling or other methods of modifying user interface page 460. Recent employer 476 is shown with an asterisk to indicate that this field has been clicked on or otherwise selected for completion by the job applicant.

Monitoring user interface 480 may include a data entry bar 482 and a QWERTY keyboard 490. Data entry bar 482, also referred to herein as an accessory bar, may include a mode toggle 485 and a data entry suggestion 486. Mode toggle 485 may be an icon, which when selected may move the monitoring user interface from the manual entry mode of monitoring user interface 480 to the copy and paste mode of monitoring user interface 430. Data entry suggestion 486 may present one or more suggestions to complete a data entry item based on the letters already typed for a given data field. Other items may be included in data entry bar 482 such as a microphone icon 489 to allow the job applicant user to verbally provide a word or phrase for entry into a data field of the body 470. QWERTY keyboard may be a touch screen data entry typewriter or other type of data entry device and/or user data entry interface.

In operation, a job applicant may be presented third party user interface 460 with job applicant name 472, job application address 474, most recent employer 476 and accompanying job title 478 as shown. Most recent employer 476 may be highlighted by the third party user interface to show that it is the next data field to be filled in by the job applicant. This highlighting of the most recent employer data field may be performed automatically by third party user interface 460 or upon a selection by the job applicant such as by a finger tap or mouse click. The job applicant may then use QWERTY keyboard 490 to enter the information requested in most recent employer 476. As the job applicant types in the information requested, monitoring user interface 480 may search the personal profile information of the job applicant to find a match and display that match as a suggestion in data entry suggestions 486. In the present example, the suggestion may be the most recent employer 476 based on the first few letters of that name being typed. The user may ignore the data entry suggestion and complete the data entry on the QWERTY keyboard until the data entry is completed, which may be indicated by hitting return on the QWERTY keyboard or by tapping the next data field to be completed. Alternatively, the user may accept the data entry suggestion by finger tapping or mouse clicking that suggestion. Upon accepting the data entry suggestion, that suggestion may be automatically filled into most recent employer 476 by monitoring user interface 480 to third party user interface 460 for filling in most recent employer 476. In addition, a record or other data representation may be generated that documents the association of the job applicant's current employer with most recent employer 476. For privacy purposes, this record may not include any specific information from the user's personal profile, just an association of the job applicant's current employer data field with most recent employer 476 data field. This record may then be stored in a database of data field associations for use in modeling the third party job application as described in greater detail herein.

FIGS. 5A-5B depict diagrams of a user interface page utilizing the generated job application model 170 to assist a job applicant in completing a job application on a third party websites, in which various embodiments of the present disclosure may be implemented. Job applicants may use a web browser to access the job applications or use a native application executing on a mobile device, such as an Indeed, Inc. of Austin, TX native application. In at least one embodiment, when a job applicant uses a native application to complete an online job application 185, as opposed to a web browser, the native application links the user to the third party website online job application 185 either directly or through a third party application. The native application then has control of the job application 180 and can auto populate the job application 180 using the machine learning, job application model 170. This job application on a third party website, including user interface pages 500 and 550, may have been invoked by the job applicant selecting apply button 377 or 387 described above with reference to FIG. 3B. User interface pages 500 and 550 may be the same user interface page shown at different points in time, including an autofill mode and a manual entry mode, which are described in greater detail below. User interface pages 500 and 550 may be displayed on a mobile phone 501 or other user device. User interface pages 500 and 550 may include two primary components, a third party website hosted job application user interface 510 and 560, also referred to herein as third party user interface 510 and 560, as well as a job application completing user interface 530 and 580, also referred to herein as completing user interface 530 and 580. That is, pages 500 and 550 may include two concurrently displayed and interacting user interfaces as described in greater detail below.

In FIG. 5A, user interface page 500 may include third party user interface 510 and assisting user interface 530 whereby the assisting user interface is in an autofill mode. That is, the user may approve or otherwise select a data entry automatically suggested by assisting user interface 530 from the generated job application model for filling a data field in third party user interface 510 as described herein. The job applicant may toggle between the autofill mode of assisting user interface 580, the manual entry mode of assisting user interface 530 by clicking on certain icons or the copy and paste mode of monitoring user interface 430 by pressing certain control characters on a keyboard of the user device, double tapping on a touch screen, or other predesignated signal.

Third party website hosted job application user interface 510 may include multiple pages or a single scrolled page of a job application to be completed online by a job applicant. Third party user interface 510 may vary significantly by the third party website hosting the job application. That is, different job providers may utilize different job applications and a single job provider may utilize different job applications for different available jobs or job types.

Third party user interface 510 may include a header 515 and a body 520. Header 515 may include identifying information regarding the job provider, the available job, the job location, and other identifying information to allow the job applicant to confirm that he or she is completing the correct job application. Body 520 may include specific fields for completion by the job application. Similar to FIGS. 4A and 4B, the present example includes job applicant name 522, job application address 524, most recent employer 526 and accompanying job title 528. Additional job application fields may be provided for completion by the job applicant through scrolling or other methods of modifying user interface page 510. Recent employer 526 is shown with an asterisk to indicate that this field has been clicked on or otherwise selected for completion by the job applicant.

Assisting user interface 530 may include automated association to personal profile information of the job applicant for use in completing the job applications displayed in third party user interface 510. That is, assisting user interface 530 may utilize the job application map to automatically provide suggested data fields from the job applicant's personal profile information to allow for rapid selective movement of that personal profile information to selected fields in third party user interface 510. Assisting user interface 530 may include an autofill bar 532 and a body 540. Autofill bar 532, also referred to herein as an accessory bar, may include a mode toggle 535 and an autofill suggestion 536. Mode toggle 535 may be an icon, which when selected may move the assisting user interface from the autofill mode of assisting user interface 530 to the manual entry mode of assisting user interface 580 or to the copy and paste mode of monitoring user interface 430. Autofill suggestion 536 may automatically present one or more suggestions to complete a data entry item based on the associated data fields in the job application model. Other items may be included in data entry bar 532 such as a microphone icon 539 to allow the job applicant user to verbally approve or modify the suggested data entry into a data field of the body 520. Body 540 may include specific fields for selection by the job applicant for use in completing the job application that are approximate to the suggested autofill entry provided above. The present example includes current employer 542, job title 544, job description 545, prior employer 546, prior job title 548 and additional work history fields 549. Additional work history fields 549 may be provided for completion by the job applicant through scrolling or other methods of modifying assisting user interface page 510. Current employer 542 is shown with an asterisk to indicate that this field has been suggested for use in completing the highlighted data field of the job application in third party user interface 510

In operation, a job applicant may be presented third party user interface 510 with job applicant name 522, job application address 524, most recent employer 526 and accompanying job title 528 as shown. Most recent employer 526 may be highlighted by the third party user interface to show that it is the next data field to be filled in by the job applicant (e.g., most recent employer 526). This highlighting of the most recent employer data field may be performed automatically by third party user interface 510 or upon a selection by the job applicant such as by a finger tap or mouse click. In response, assisting user interface 530 may utilize the job application model to identify an associated data field from personal profiles (e.g., a current employer data field), retrieve that data from the job applicant's personal profile (e.g., current employer 542), and suggest that data to the job applicant in autofill suggestion 542. Assisting user interface 530 may also retrieve and display accompanying information from the job applicant's personal profile, such as shown in body 540. The job applicant may then select the autofill suggestion 542, one of the other displayed data fields in body 540 or proceed to a different mode by selecting mode toggle 535. If the autofill suggestion is selected by the job applicant, the information in current employer 542 may then be automatically filled into most recent employer 526. In addition, a record or other data representation may be generated that further documents the association of current employer 542 with most recent employer 526. This record will help confirm that the previous association of these two data fields is current. For privacy purposes, this record may not include any specific information from the user's personal profile, just an association of the job applicant's current employer 542 data field with most recent employer 576 data field. If the job applicant selects one of the other displayed data fields in body 540, then that data may be automatically copy and pasted into most recent employer 526. In addition, a record or other data representation may be generated that documents the association of that data field with most recent employer 526. For privacy purposes, this record may not include any specific information from the user's personal profile, just an association of the selected data field with most recent employer 526 data field. These records may then be stored in a database of data field associations for use in modeling the third party job application as described in greater detail herein.

In FIG. 5B, user interface page 550 may include third party user interface 560 and assisting user interface 580 whereby the assisting user interface is in a manual entry mode. That is, the user may manually enter data into a selected data field from third party user interface 560 as described herein. For example, assisting user interface 580 may include a QWERTY keyboard for manual typing of data for entry into a data field in third party user interface 560. The job applicant may toggle between the autofill mode of assisting user interface 530 and the manual entry mode of assisting user interface 580 or to the copy and paste mode of monitoring user interface 430 by clicking on certain icons, by pressing certain control characters on a keyboard of the user device, double tapping on a touch screen, or other predesignated signal. FIG. 5B may be similar to FIG. 4B except that the job application model may be utilized for identifying data fields for a suggested data entry.

Third party website hosted job application user interface 560 may include multiple pages or a single scrolled page of a job application to be completed online by a job applicant. Third party user interface 560 may vary significantly by the third party website hosting the job application. That is, different job providers may utilize different job applications and a single job provider may utilize different job applications for different available jobs or job types.

Third party user interface 560 may include a header 565 and a body 570. Header 565 may include identifying information regarding the job provider, the available job, the job location, and other identifying information to allow the job applicant to confirm that he or she is completing the correct job application. Body 570 may include specific fields for completion by the job application. Similar to FIGS. 4A, 4B and 5A, the present example includes job applicant name 572, job application address 574, most recent employer 576 and accompanying job title 578. Additional job application fields may be provided for completion by the job applicant through scrolling or other methods of modifying user interface page 560. Recent employer 576 is shown with an asterisk to indicate that this field has been clicked on or otherwise selected for completion by the job applicant.

Assisting user interface 580 may include a data entry bar 582 and a QWERTY keyboard 590. Data entry bar 582, also referred to herein as an accessory bar, may include a mode toggle 585 and a data entry suggestion 586. Mode toggle 585 may be an icon, which when selected may move the assisting user interface from the manual entry mode of assisting user interface 580 to the autofill mode of assisting user interface 530 or to the copy and paste mode of monitoring user interface 430. Data entry suggestion 586 may present one or more suggestions to complete a data entry item based on the letters already typed for a given data field. Other items may be included in data entry bar 582 such as a microphone icon 589 to allow the job applicant user to verbally provide a word or phrase for entry into a data field of the body 570. QWERTY keyboard may be a touch screen data entry typewriter or other type of data entry device and/or user data entry interface.

In operation, a job applicant may be presented third party user interface 560 with job applicant name 572, job application address 574, most recent employer 576 and accompanying job title 578 as shown. Most recent employer 576 may be highlighted by the third party user interface to show that it is the next data field to be filled in by the job applicant. This highlighting of the most recent employer data field may be performed automatically by third party user interface 560 or upon a selection by the job applicant such as by a finger tap or mouse click. The job applicant may then use QWERTY keyboard 590 to enter the information requested in most recent employer 576. As the job applicant types in the information requested, assisting user interface 580 may first search the job application model, then search the personal profile information of the job applicant to find a match and display that match as a suggestion in data entry suggestion 586. In the present example, the suggestion may be the most recent employer 576 based on the first few letters of that name being typed. The user may ignore the suggestion and complete the data entry on the QWERTY keyboard until the data entry is completed, which may be indicated by hitting return on the QWERTY keyboard or by tapping the next data field to be completed. Alternatively, the user may accept the suggestion by finger tapping or mouse clicking the data entry suggestion. Upon accepting the suggestion, that suggestion may be automatically filled into most recent employer 576 by assisting user interface 570 to third party user interface 560 for filling in most recent employer 576. In addition, a record or other data representation may be generated that documents the association of the job applicant's current employer with most recent employer 576. For privacy purposes, this record may not include any specific information from the user's personal profile, just an association of the job applicant's current employer data field with most recent employer 576 data field. This record may then be stored in a database of data field associations for use in modeling the third party job application as described in greater detail herein.

FIG. 6 depicts a flow diagram 600 of the user interface monitoring a job applicant completing a job application on a third party website towards generating a job application model of that job application, in which various embodiments of the present disclosure may be implemented. FIG. 6 is described with reference to the job application management system 120 of FIG. 1 as well as with the user interfaces described with reference to FIGS. 4A-4B. In at least one embodiment, the following may be performed for all third party job application websites accessible through the job application management system, although it may be limited to certain job application websites based on prior experience or other factors.

In operation 605, responsive to the job applicant 110 selecting association to an online job application 185 in user interface 130, an initial determination is made whether job application management system 120 has a previously generated map or model of the online job application. This may be determined by front end 131 providing the job applicant selected association to back end 135 which compares the online job application association to associations associated with previously modeled job applications in job application model 170. An association may include the URL (uniform resource locator) of the job application website and/or subsets thereof such as the top level domain. If there is not a previously modeled job application in the job application model database, then processing will continue to operation 610 below. Otherwise, processing would continue to operation 810 as described below with reference to FIG. 8.

Then in operation 610, the job applicant's online session is directed by the front end of user interface 130 through data association manager 132 to third party website 180 associated with online job application. As described above, this association may be a URL web address. In the case of the job applicant utilizing a mobile device for querying jobs available database 145, the job applicant may be directed through data association manager 132 to the associated third party website 180 through a local browser or other portal that is hosted or otherwise monitored by data association manager 132. In an alternative embodiment, the association may be to a third party app which is invoked in this operation and then engaged similar to a third party website as described herein.

Then in operation 615, upon accessing the online job application webpage, a communication pathway is established by data association manager 132 between front end 131 of user interface 130 and third party website 180. For example, some JavaScript may be injected or otherwise provided by data association manager 132 to third party job application website 180 to monitor and/or assist the job applicant during the job application process. In the case of the job applicant utilizing a desktop or other non-mobile device, a monitoring and assisting plug-in may be provided by data association manager 132 to the non-mobile device browser for implementation on that device. In either case, this communication pathway allows the job application management system to monitor and/or assist with the job application process on the third party website. That is, responsive to the job applicant selecting the online job application association in the query results, user interface 130 provides to the job applicant online access to the associated third party job application website 180 while maintaining sufficient access to monitor and/or assist the job applicant in completing online job application 185.

Then in optional operation 620, job application 185 may be analyzed by the user interface for identifying various attributes of the job application towards possible use in modeling that job application. For example, user interface 130 may utilize JavaScript or other software tools for identifying the underlying job application software such as the topological or other attributes of the job application website. This could include identifying the various variables utilized by the job application, the order in which those variables may be displayed for job applicant input, and other attributes of the job application. These attributes may then be grouped and associated with the association and forwarded by front end 131 to backend 135 for storage in usage data storage unit 150 for future use in modeling the job application. In addition, these attributes may be utilized to identify whether there may be a matching job application model in job application model 170. If so, that matching job application model may be utilized in assisting the job applicant in completing the job application. In such a case, processing may proceed to FIG. 8 below, otherwise processing would continue to operation 625.

In operation 625, the job applicant's profile is uploaded from job applicant profile database 140 by backend 135 to frontend 131. This personal profile may be uploaded for each job application the job applicant selects for completion as the job applicant may update their profile between job applications. This may include all elements of the job applicant's personal profile, or a predetermined subset of that personal profile. This may include the job applicant's name, address, prior and current work experience, educational experience, etc.

In operation 630, the job application is displayed concurrently with job application monitoring user interface 430 by front end 131 of the user interface in a job application session. That is, front end 131 provides an interactive copy of the updated job applicant profile with an accessory bar 432 for display concurrently with third party job application 185 such as described above with reference to FIG. 4A. At this point, the user interface is in a copy and paste mode so the job applicant is able to view as well as select various data fields of the displayed job applicant profile for entering into selected fields of the third party job application website. However, if the user selects toggle 435, the user interface may be placed in a manual entry mode for manual entry of data into the job application data fields, such as shown with reference to FIG. 4B. In the manual entry mode, the job applicant's profile may be displayed as a type of keyboard overlaying a displayed keyboard, such as over a displayed keyboard on a mobile device, which the user may then scroll and select for entry into a selected job application field. In alternative embodiments, the job applicant's profile may be displayed in a pop-up box, in a separate concurrently displayed window, in a toggled display, or other display type that allows the job applicant to view his or her personal profile as well as copy or click selected fields from the personal profile to fill selected fields on the online job application.

Then in operation 635, the front end of the user interface monitors the actions of the job applicant and the third party job application to determine which data field of the job application the job applicant is activated for completion. A data field may be active and indicated for completion by the third party job application highlighting a data field, by the user point and clicking a data field with a mouse, a combination thereof, or other indicators. This data field may be identified through the use of JavaScript, utilized by front end 131, interacting with the job application website and utilizing x paths to identify which data field is being completed and the job application variable associated with that data field. Also, in operation 640, the front end of the user interface provides data fields from the personal profile to the job applicant in response to user selections. These user selections may be made through user manipulation of the accessory bar in the copy and paste mode and or data typed using the displayed keyboard in the manual entry mode. In addition, if the user interface is in the manual entry mode, as the job applicant types in data, matching data from the personal profile may be displayed in the accessory bar.

Then in operation 645, the front end of the user interface monitors the job applicant selecting data from his or her personal profile to fill certain fields in the third party job application. For example, if the job applicant selects data from a “prior experience start date” field for filling an identified field on the job application, then that movement of data is detected. Detecting movement of such data may be by detecting a copy and paste, a click and point, or other known ways for selecting and filling or otherwise moving data from one webpage document to another. Other types of data entry by the job applicant may also be detected such as the job applicant selecting a “next” button on the job application. That is, a job application may include multiple pages that need to be processed and completed by the job applicant, so such data entry of these operations may also be detected.

Then in operation 650, responsive to detecting the movement of data from a personal profile to a third party job application as described above, a data point, is automatically generated identifying the data association between each field selected from the personal profile and the associated field selected from the third party job application. That is, each time a job applicant selects data from a first field from his or her personal profile to fill in a second field in the third party job application, a data point is generated identifying the data association between the first data field of the personal profile to the second data field of the third party job application. The underlying data being selected and filled may not be included in the data point, just identification of the data fields and the associated variables, so as to avoid propagating personal data and preserving user privacy. Additional data points may also be automatically generated identifying other job applicant data actions that do not include moving data from the personal profile to the third party job application. For example, if a user clicks a “next” button on the third party job application, a data point may be generated identifying that action taken with the job application field selected by the job applicant on the third party job application.

Operations 630-650 may be repeated many times until the job applicant has completed the third party job application or otherwise discontinues the job application session. For example, the job applicant may hit a submit button of the third party job application, save and close the job application session, or just leave the session altogether. In operation 651, it is determined whether the user has discontinued completing the job application, whether by submission or other discontinuation. Upon the job applicant discontinuing the job application session, in operation 655, the data points are stored in a usage data storage unit 150 with timing information and associated contextual information such as the third party job application URL (uniform resource locator) and type of licensed software utilized by the third party job application website. This includes storing the data association data points and the action taken data points along with the contextual information with timing information. The timing information may be the date and time the job applicant utilizes a third party job application website. This timing information may be retained for use in determining whether the associated data points and contextual information are potentially out of date and no longer useful or just older than other more recently gathered usage data.

Operations 605-655 may be repeated for multiple job applicants utilizing the job application management system user interface 130 for applying for multiple jobs across multiple third party job application websites. As a result, usage data storage unit 150 may contain many data points and associated contextual information identifying associations between personal profile data fields and third party job application website data fields for multiple job applicants and multiple third party job application websites. Once a threshold amount of data has been collected in the usage data storage unit, in total or in sufficient numbers for a given third party job application website, the processing operations of FIG. 7 may be triggered to generate or update models of online job applications 185 on third party job application websites 180.

FIG. 7 depicts a flow diagram 700 of the job application management system generating a model of a third party job application, in which various embodiments of the present disclosure may be implemented. FIG. 7 is discussed with reference to the job application management system 120 of FIG. 1 as well as with reference to other Figures described herein.

In a first operation 705, such as described herein with reference to FIGS. 6 and 8, user interface 130 may collect a set of data points and associated contextual information identifying associations between personal profile data fields and third party job application website data fields for multiple job applicants and multiple third party job application websites in usage data storage unit 150. Then in operation 710, it is determined whether any threshold has been met to trigger an analysis of the data points by usage data manager 155. This threshold may be in terms of time whereby the modeling analysis is performed periodically, upon a selected set of models reaching a time period since they were last updated, or possibly every time the usage data storage unit is updated. This threshold may also be in terms of the amount of data points collected in usage data storage unit 150, whether in total or for any given third party job provider or other categorization of data. As may be appreciated by one of ordinary skill in the art, other thresholds may be utilized, including multiple types of thresholds, to initiate an analysis of the data points by usage data manager 155. If a threshold has not been met, then trigger 156 does not initiate usage data manager 155 action and processing returns to operation 705. If a threshold has been met, then trigger 156 initiates an analysis of the data points by usage data manager 155 and processing continues to operation 715.

In operation 715, usage data manager 155 may aggregate the data points stored in usage data storage system by associations that were utilized to access the online third party job applications. Such associations may include the URL (uniform resource locator) of the job application website and/or subsets thereof such as the top level domain. Alternatively, topological or other attributes of the third party job applications may be utilized for aggregating the data points stored in usage data storage system. By using attributes for aggregating data points, models may be generated that could be useful across job applications of different third parties, such as if such third parties utilize common software for their job application websites. Then in operation 720, usage data manager 155 may delete, inactivate or otherwise archive certain data points. Such archiving may be based on the age of the data points, the number of data points per aggregation, and/or other factors. This archiving may allow the job application management system to more rapidly adapt to changes in third party job applications.

In operation 725, the aggregated data points from the above operations are forwarded by usage data manager 155 to job application modeling system 160 for generating job application models. Job application modeling system may be a reinforcement learning system, such as artificial intelligence, or a set of statistical analytical tools useful for identifying statistically significant associations. In operation 730, job application modeling system may analyze the aggregated data points to identify significant associations between data fields of the third party job application 180 and the data fields of the personal profile as organized in job application profile database 140. As mentioned above, these data fields may not contain any personal information of the job applicants. Instead, these data fields may include variable names as identified above that are associated with those data fields. This allows the job application modeling system to identify data fields in the personal profile database that may be utilized to fill or other complete data fields in the third party job application. In operation 735, upon identifying a significant correlation between third party job application data fields and personal profile data fields, a node may be generated of a model of the third party application. A predetermined threshold amount may be utilized for determining whether the correlation is significant enough for generating a node. This node may include the third party data field and associated variable, the personal profile data field and associated variable (or other pointer), identification of the associated association for the third party job application, a date and time stamp the node was generated, and other relevant information.

In operation 740, it is determined whether the model generation process has been completed. That is, if there are still additional aggregated data points for analysis, the process may return to operation 725, otherwise, processing continues to operation 745. That is, operations 725 through 735 may be repeated until models of third party job applications are generated, each model including a set of nodes, each node representing the third party data field and associated variable correlated with the personal profile data field and associated variable.

In operation 745, job application modeling system 160 may generate a set of models, each model including a set of nodes, for storage in job application model 170. This may include replacing previously generated models for previously modeled third party job applications. As described in greater detail below with reference to FIG. 8, these job application models may be useful for enabling user interface 130 to assist job applicants 110 in completing online job applications 185.

FIG. 8 depicts a flow diagram 800 of the job application management system utilizing models for assisting a job applicant in completing an online job application, in which various embodiments of the present disclosure may be implemented. Concurrently with assisting the job applicant in completing the job application, the job application system may also verify and update the modeled online job application website. FIG. 8 is described with reference to the job application management system 120 of FIG. 1 as well as with the user interfaces described with reference to FIGS. 5A-5B. In at least one embodiment, the following may be performed for all third party job application websites accessible through the job application management system, although it may be limited to certain job application websites based on prior experience or other factors.

In operation 805, responsive to the job applicant 110 selecting association to an online job application 185 in user interface 130, an initial determination is made whether job application management system 120 has a previously generated map or model of the online job application. This may be determined by front end 131 providing the job applicant selected association to back end 135 which compares the online job application association to associations associated with previously modeled job applications in job application model 170. An association may include the URL (uniform resource locator) of the job application website and/or subsets thereof such as the top level domain. If there is not a perfect match, then a threshold may be utilized to determine whether there is a sufficient match to use the identified job application model. If there is a previously modeled job application in the job application model database, then processing will continue to operation 806 below. Otherwise, processing would continue to operation 610 described above with reference to FIG. 6.

In operation 806, the previously generated job application model identified in operation 805 is uploaded to the user interface. That is, backend 135 uploads the identified job application model from job application model 170 and provides that model for use by front end 131. This model may include a set of associations between data fields of the third party job application, including the underlying variables of those data fields, and data fields of personal profiles in job applicant profile database 140. In an alternative embodiment, only a subset of the identified job application model may be uploaded in this operation, with additional subsets uploaded each time a data field of the job application is identified for completion in operation 835 below.

Then in operation 810, the job applicant's online session is directed by the front end of user interface 130 through data association manager 132 to third party website 180 associated with online job application. As described above, this association may be a URL web address. In the case of the job applicant utilizing a mobile device for querying jobs available database 145, the job applicant may be directed through data association manager 132 to the associated third party website 180 through a local browser or other portal that is hosted or otherwise monitored by data association manager 132. In an alternative embodiment, the association may be to a third party app which is invoked in this operation and then engaged similar to a third party website as described herein.

Then in operation 815, upon accessing the online job application webpage, a communication pathway is established by data association manager 132 between front end 131 of user interface 130 and third party website 180. For example, some JavaScript may be injected or otherwise provided by data association manager 132 to third party job application website 180 to monitor and assist the job applicant during the job application process. In the case of the job applicant utilizing a desktop or other non-mobile device, a monitoring and assisting plug-in may be provided by data association manager 132 to the non-mobile device browser for implementation on that device. In either case, this communication pathway allows the job application management system to monitor and assist with the job application process on the third party website. That is, responsive to the job applicant selecting the online job application association in the query results, user interface 130 provides to the job applicant online access to the associated third party job application website 180 while maintaining sufficient access to monitor and assist the job applicant in completing online job application 185. This plug-in may be the same plug-in described above with reference to operation 615.

Then in optional operation 820, job application 185 may be analyzed by the user interface for identifying various attributes of the job application towards possible use in modeling that job application. For example, user interface 130 may utilize JavaScript or other software tools for identifying the underlying job application software such as the topological or other attributes of the job application website. This could include identifying the various variables utilized by the job application, the order in which those variables may be displayed for job applicant input, and other attributes of the job application. These attributes may then be grouped and associated with the association and forwarded by front end 131 to backend 135 for storage in usage data storage unit 150 for future use in modeling the job application.

In operation 825, the job applicant's profile is uploaded from job applicant profile database 140 by backend 135 to frontend 131. This personal profile may be uploaded for each job application the job applicant selects for completion as the job applicant may update their profile between job applications. This may include all elements of the job applicant's personal profile, or a predetermined subset of that personal profile. This may include the job applicant's name, address, prior and current work experience, educational experience, etc.

In operation 830, the job application is displayed concurrently with job application assisting user interface 530 by front end 131 of the user interface in a job application session. That is, front end 131 provides an interactive copy of the updated job applicant profile with an accessory bar 532 for display concurrently with third party job application 185 such as described above with reference to FIG. 5A. At this point, the user interface may be in an autofill mode so the job applicant is able to view and select autofill suggestions in the accessory bar as well as access various data fields of the displayed job applicant profile for entering into selected fields of the third party job application website. However, if the user selects toggle 535, the user interface may be placed in a manual entry mode for manual entry of data into the job application data fields, such as shown with reference to FIG. 5B. In the manual entry mode, the job applicant's profile may be displayed as a type of keyboard overlaying a displayed keyboard, such as over a displayed keyboard on a mobile device, which the user may then scroll and select for entry into a selected job application field. In alternative embodiments, the job applicant's profile and recommended autofill suggestions may be displayed in a pop-up box, in a separate concurrently displayed window, in a toggled display, or other display type that allows the job applicant to view his or her personal profile as well as copy or click selected fields from the personal profile to fill selected fields on the online job application.

In operation 835, the front end of the user interface monitors the actions of the job applicant and the third party job application to determine which data field of the job application the job applicant is activated for completion. A data field may be active and indicated for completion by the third party job application highlighting a data field, by the user point and clicking a data field with a mouse, a combination thereof, or other indicators. This data field may be identified through the use of JavaScript, utilized by front end 131, interacting with the job application website and utilizing x paths to identify which data field is being completed and the job application variable associated with that data field. In operation 836, upon identifying a data field indicated for completion, the user interface identifies an associated data field from the uploaded job application model. Then in operation 840, the front end of the user interface provides autofill suggestions from the identified data field of the job applicant's personal profile to the job applicant in the accessory bar based on the modeled association. In addition, in at least one embodiment, if the user interface is in the manual entry mode, as the job applicant types in data, matching data from the personal profile may be displayed in the accessory bar.

Then in operation 845, the front end of the user interface monitors the job applicant selecting data from his or her personal profile, whether from the autofill suggestions in the accessory bar or other user selections from his or her personal profile, to fill certain fields in the third party job application. For example, if the job applicant selects data from a “prior experience start date” field for filling an identified field on the job application, then that movement of data is detected. Detecting movement of such data may be by detecting a copy and paste, a click and point, or other known ways for selecting and filling or otherwise moving data from one webpage document to another. Other types of data entry by the job applicant may also be detected such as the job applicant selecting a “next” button on the job application. That is, a job application may include multiple pages that need to be processed and completed by the job applicant, so such data entry of these operations may also be detected.

Then in operation 850, responsive to detecting the movement of data from a personal profile to a third party job application as described above, a data point is automatically generated identifying the data association between each data field selected from the personal profile and the associated data field selected from the third party job application. That is, each time a job applicant selects data from a first field from his or her personal profile to fill in a second field in the third party job application, such as by selecting an autofill suggestion to complete a job application data field, a data point is generated identifying the data association between the first data field of the personal profile to the second data field of the third party job application. The underlying data being selected and filled may not be included in the data point, just identification of the data fields and the associated variables, so as to avoid propagating personal data and preserving user privacy. Additional data points may also be automatically generated identifying other job applicant data actions that do not include moving data from the personal profile to the third party job application. For example, if a user clicks a “next” button on the third party job application, a data point may be generated identifying that action taken with the job application field selected by the job applicant on the third party job application.

Operations 830-550 may be repeated many times until the job applicant has completed the third party job application or otherwise discontinues the job application session. For example, the job applicant may hit a submit button of the third party job application, save and close the job application session, or just leave the session altogether. In operation 851, it is determined whether the user has discontinued completing the job application, whether by submission or other discontinuation. Upon the job applicant discontinuing the job application session, in operation 855, the data points are stored in a usage data storage unit 150 with timing information and associated contextual information such as the third party job application URL (uniform resource locator) and type of licensed software utilized by the third party job application website. This includes storing the data association data points and the action taken data points along with the contextual information with timing information. The timing information may be the date and time the job applicant utilizes a third party job application website. This timing information may be retained for use in determining whether the associated data points and contextual information are potentially out of date and no longer useful or just older than other more recently gathered usage data.

Operations 805-855 may be repeated for multiple job applicants utilizing the job application management system user interface 130 for applying for multiple jobs across multiple third party job application websites. As a result, usage data storage unit 150 may contain many data points and associated contextual information identifying associations between personal profile data fields and third party job application website data fields for multiple job applicants and multiple third party job application websites. Periodically, the processing operations of FIG. 7 may be triggered to update models of online job applications 185 on third party job application websites 180.

Provided below in the following tables is pseudocode which may be utilized by one of ordinary skill in the art in implementing an embodiment of a job application management system, such as described above, without undue experimentation. The immediately following pseudocode of operations which may be taken when a job applicant invokes a third party job application. In this pseudocode, both the third party job application and a subset of the job applicant's personal profile are displayed, including an accessory bar.

```
// called when page created after user chooses to
apply for a job on a third party website
def setupAccessoryBar( ) {
  var resumeData = downloadCurrentResumeData( );
  // example of resumeData
  // {
  // ″Personal Info″: {
  // ″firstName″: ″John″,
  // ″lastName″: ″Doe″,
  // ″email″: ″john.doe@somewhere.com″
  // },
  // ″Work Info″: {
  // ″Company″: ″Super Company″,
  // ″Job Title″: ″Manger 1″,
  // ″Job Description″: ″I managed people...″
  // }
  }
```

The immediately following pseudocode provides operations which may be taken by the user interface for establishing a communication path with the third party job application including implementing JavaScript shown in the pseudocode that may be taken by JavaScript to establish a communication path with the third party job application.

// get known info about this site/application
var siteInfo = getInfoForSite(siteIdentifier);
// example of site info
// {
// ″xpath″: ″xpath to specific nodeElement″, // ML generated
// ″suggestionType″: ″firstName″
// }
// put custom javascript into webpage
sendJavascriptFileToWebPage( );
bridge.setupPage(siteInfo);
}

The immediately following pseudocode provides pseudocode of operations which may be taken by the user interface to provide autofill suggestions in the accessory bar.

```
def nativeAppShowResumeInfo(suggestionFor) {
  // example of suggestionFor
  // ″firstName″, ″email″, etc.
  if (exists(resumeData[suggestionFor])) {
    show SpecificSuggestion( );
  }
  attachResumeInfoToKeyboard( );
  }
  def userSelectedResumeInfo( ) {
    sendJavascriptToWebview
    (sendResultToWebpage(key, resumeData[key]));
}
def logUserInteraction(key, nodeData) {
  storeDataAsUserInteraction(key, nodeData);
```

The immediately following pseudocode may be taken by JavaScript to establish a communication path with the third party job application.

```
var globalSiteInfoList = [ ];
def setupPage(siteInfo) {
  // example of single siteinfo object in list
  // {
  // ″xpath″: ″xpath to specific nodeElement″, // ML generated
  // ″suggestionType″: ″firstName″
  // }
  globalSiteInfoList = siteInfoList;
}
listen.onInputFieldType(( ) -> {
  var suggestionFor = null;
  foreach( info : globalSiteInfoList ) {
    if (info.xpath matches nodeElement) {
      suggestionFor = info.suggestionType;
    }
  bridge.nativeAppShowResumeInfo(suggestionFor);
}
def sendResultToWebpage(key, value) {
  // gather information about this input element
  // i.e., id, class, type, parent id, parent class, parent type, etc.
  var nodeData = getInputNodeElementInformation( );
  // this puts resume data into application on webpage
  insertValueIntoInputField(value);
  // this sends nodeElement and key associated with it for logging
  bridge.logUserInteraction(key, nodeData);
}
```

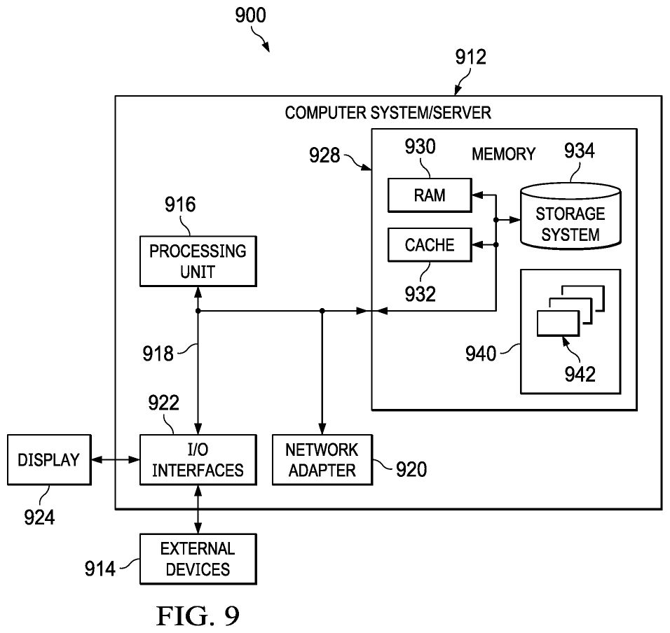

FIG. 9 depicts a block diagram of an illustrative data processing system in which various embodiments of the present disclosure may be implemented. Data processing system 900 is one example of a suitable data processing system and is not intended to suggest any limitation as to the scope of use or functionality of the embodiments described herein. Regardless, data processing system 900 is capable of being implemented and/or performing any of the functionality set forth herein such as automatically modeling online job applications on third party websites for facilitating job application completion.

In data processing system 900 there is a computer system/server 912, which is operational with numerous other computing system environments, peripherals, or configurations. Examples of well-known computing systems, environments, and/or configurations that may be suitable for use with computer system/server 912 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 912 may be described in the general context of computer system-performable instructions, such as program modules, being processed by a computer system. Generally, program modules may include routines, programs, objects, components, logic, data structures, and so on that perform particular tasks or implement particular abstract data types. Computer system/server 912 may be practiced in distributed computing environments where tasks are performed by remote processing devices that are linked through a communications network. In a distributed computing environment, program modules may be located in both local and remote computer system storage media including memory storage devices. For example, the system and method for automatically modeling online job applications may be implemented in a cloud computing environment, distributed or otherwise, which may be virtualized such as with the use of a hypervisor managing multiple nodes including virtual processors, virtual memory, etc.

As shown in FIG. 9, computer system/server 912 in data processing system 900 is shown in the form of a general-purpose computing device. The components of computer system/server 912 may include, but are not limited to, one or more processors or processing units 916, a system memory 928, and a bus 918 that couples various system components including system memory 928 to processor 916.

Bus 918 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 912 typically includes a variety of non-transitory computer system usable media. Such media may be any available media that is accessible by computer system/server 912, and it includes both volatile and non-volatile media, removable and non-removable media.

System memory 928 may include non-transitory computer system readable media in the form of volatile memory, such as random access memory (RAM) 930 and/or cache memory 932. Computer system/server 912 may further include other non-transitory removable/non-removable, volatile/non-volatile computer system storage media. By way of example, storage system 934 can be provided for reading from and writing to a non-removable, non-volatile magnetic media (not shown and typically called a “hard drive”). Although not shown, a USB interface for reading from and writing to a removable, non-volatile magnetic chip (e.g., a “flash drive”), and an optical disk drive for reading from or writing to a removable, non-volatile optical disk such as a CD-ROM, DVD-ROM or other optical media can be provided. In such instances, each can be connected to bus 918 by one or more data media interfaces. Memory 928 may include at least one program product having a set (e.g., at least one) of program modules that are configured to carry out the functions of the embodiments. Memory 928 may also include data that will be processed by a program product.

Program/utility 940, having a set (at least one) of program modules 942, may be stored in memory 928 by way of example, and not limitation, as well as an operating system, one or more application programs, other program modules, and program data. Each of the operating system, one or more application programs, other program modules, and program data or some combination thereof, may include an implementation of a networking environment. Program modules 942 generally carry out the functions and/or methodologies of the embodiments. For example, a program module may be software for automatically modeling online job applications on third party websites for facilitating job application completion.

Computer system/server 912 may also communicate with one or more external devices 914 such as a keyboard, a pointing device, a display 924, etc.; one or more devices that enable a user to interact with computer system/server 912; and/or any devices (e.g., network card, modem, etc.) that enable computer system/server 912 to communicate with one or more other computing devices. Such communication can occur via I/O interfaces 922 through wired connections or wireless connections. Still yet, computer system/server 912 can communicate with one or more networks such as a local area network (LAN), a general wide area network (WAN), and/or a public network (e.g., the Internet) via network adapter 920. As depicted, network adapter 920 communicates with the other components of computer system/server 912 via bus 918. It should be understood that although not shown, other hardware and/or software components could be used in conjunction with computer system/server 912. Examples, include, but are not limited to microcode, device drivers, tape drives, RAID systems, redundant processing units, data archival storage systems, external disk drive arrays, etc.

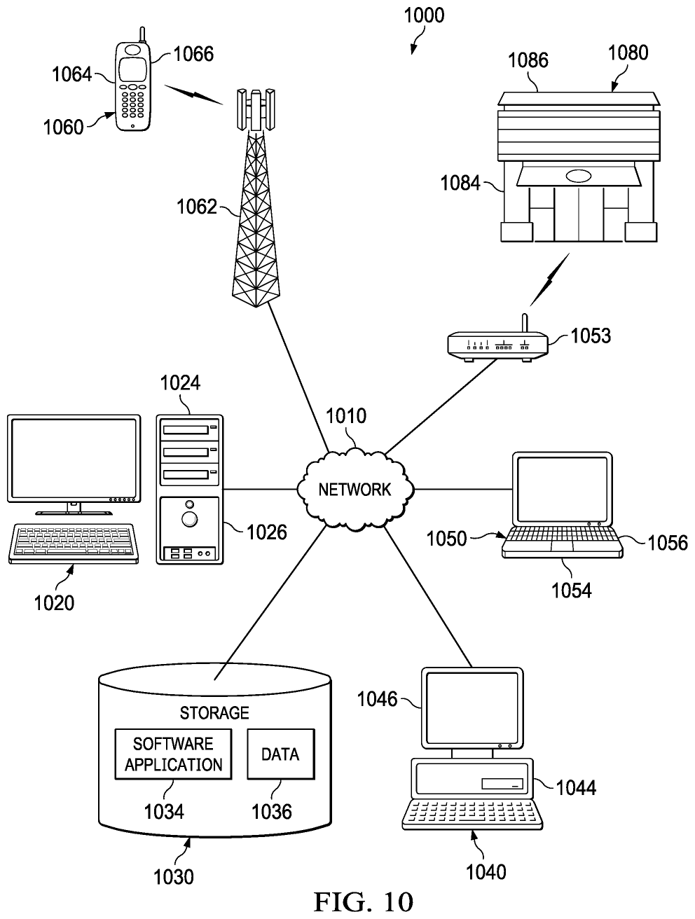

FIG. 10 depicts a block diagram of an illustrative network of data processing systems in which various embodiments of the present disclosure may be implemented. Data processing environment 1000 is a network of data processing systems such as described above with reference to FIG. 9. Software applications such as for automatically modeling online job applications on third party websites for facilitating job application completion may be processed on any computer or other type of data processing system in data processing environment 1000. Data processing environment 1000 includes network 1010. Network 1010 is the medium used to provide simplex, half duplex and/or full duplex communications links between various devices and computers connected together within data processing environment 1000. Network 1010 may include connections such as wire, wireless communication links, or fiber optic cables.

Server 1020 and client 1040 are coupled to network 1010 along with storage unit 1030. In addition, laptop 1050 and facility 1080 (such as a home or business) are coupled to network 1010 including wirelessly such as through a network router 1053. A mobile device 1060 such as a mobile phone may be coupled to network 1010 through a cell tower 1062. Data processing systems, such as server 1020, client 1040, laptop 1050, mobile device 1060 and facility 1080 contain data and have software applications including software tools processing thereon. Other types of data processing systems such as personal digital assistants (PDAs), smartphones, tablets and netbooks may be coupled to network 1010.

Server 1020 may include software application 1024 and data 1026 for automatically modeling online job applications on third party websites for facilitating job application completion or other software applications and data in accordance with embodiments described herein. Storage 1030 may contain software application 1034 and a content source such as data 1036 for automatically modeling online job applications on third party websites for facilitating job application completion. Other software and content may be stored on storage 1030 for sharing among various computer or other data processing devices. Client 1040 may include software application 1044 and data 1046. Laptop 1050 and mobile device 1060 may also include software applications 1054 and 1064 and data 1056 and 1066. Facility 1080 may include software applications 1084 and data 1086 on local data processing equipment. Other types of data processing systems coupled to network 1010 may also include software applications. Software applications could include a web browser, email, or other software application for automatically modeling online job applications on third party websites for facilitating job application completion.

Server 1020, storage unit 1030, client 1040, laptop 1050, mobile device 1060, and facility 1080 and other data processing devices may couple to network 1010 using wired connections, wireless communication protocols, or other suitable data connectivity. Client 1040 may be, for example, a personal computer or a network computer.

In the depicted example, server 1020 may provide data, such as boot files, operating system images, and applications to client 1040 and laptop 1050. Server 1020 may be a single computer system or a set of multiple computer systems working together to provide services in a client server environment. Client 1040 and laptop 1050 may be clients to server 1020 in this example. Client 1040, laptop 1050, mobile device 1060 and facility 1080 or some combination thereof, may include their own data, boot files, operating system images, and applications. Data processing environment 1000 may include additional servers, clients, and other devices that are not shown.

In the depicted example, data processing environment 1000 may be the Internet. Network 1010 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 1000 also may be implemented as a number of different types of networks, such as for example, an intranet, a local area network (LAN), or a wide area network (WAN). FIG. 10 is intended as an example, and not as an architectural limitation for the different illustrative embodiments.

Among other uses, data processing environment 1000 may be used for implementing a client server environment in which the embodiments may be implemented. A client server environment enables software applications and data to be distributed across a network such that an application functions by using the interactivity between a client data processing system and a server data processing system. Data processing environment 1000 may also employ a service oriented architecture where interoperable software components distributed across a network may be packaged together as coherent business applications.

The system and method for automatically modeling online job applications may also be stored as executable code in a computer program product causing a processor to carry out aspects of the system and method for automatically modeling online job applications.

The computer readable storage medium can be a tangible device that can retain and store instructions for use by an instruction processing device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++ or the like, and procedural programming languages, such as the “C” programming language or other programming languages such as Java. The computer readable program instructions may be processed entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may process the computer readable program instructions by utilizing state information of the computer readable program instructions to personalize the electronic circuitry, in order to perform aspects of the system and method for automatically modeling online job applications on third party websites.

Aspects of the system and method for automatically modeling online job applications on third party websites are described herein with reference to flowchart illustrations and/or block diagrams of methods, apparatus (systems), and computer program products according to embodiments of the system and method for automatically modeling online job applications on third party websites. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer or other programmable data processing apparatus to produce a special purpose machine, such that the instructions, which are processed via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational operations to be performed on the computer, other programmable apparatus or other device to produce a computer implemented process, such that the instructions which are processed on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the system and method for automatically modeling online job applications on third party websites. In this regard, each block in the flowchart or block diagrams may represent a module, segment, or portion of instructions, which comprises one or more performable instructions for implementing the specified logical function(s). In some alternative implementations, the functions noted in the blocks may occur out of the order noted in the Figures. For example, two blocks shown in succession may, in fact, be processed substantially concurrently, or the blocks may sometimes be processed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

A data processing system suitable for storing and/or processing program code will include at least one processor coupled directly or indirectly to memory elements through a system bus. The memory elements can include local memory employed during actual processing of the program code, bulk storage media, and cache memories, which provide temporary storage of at least some program code in order to reduce the number of times code must be retrieved from bulk storage media during processing.

A data processing system may act as a server data processing system or a client data processing system. Server and client data processing systems may include data storage media that are computer usable, such as being computer readable. A data storage medium associated with a server data processing system may contain computer usable code such as for automatically modeling online job applications on third party websites for facilitating job application completion. A client data processing system may download that computer usable code, such as for storing on a data storage medium associated with the client data processing system, or for using in the client data processing system. The server data processing system may similarly upload computer usable code from the client data processing system such as a content source. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The descriptions of the various embodiments of the system and method for automatically modeling online job applications on third party websites have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The terminology used herein is for the purpose of describing particular embodiments and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, operations, operations, elements, and/or components, but do not preclude the presence or addition of one or more other features, integers, operations, operations, elements, components, and/or groups thereof.

The corresponding structures, materials, acts, and equivalents of all means or operation plus function elements in the claims below are intended to include any structure, material, or act for performing the function in combination with other claimed elements as specifically claimed. The description of the system and method for automatically modeling online job applications on third party websites has been presented for purposes of illustration and description but is not intended to be exhaustive or limited. Many modifications and variations will be apparent to those of ordinary skill in the art without departing from the scope and spirit of the invention.

What is claimed is:

1. A method of modeling and enabling a data processing system to automatically complete an online job application on a third party website, the method comprising:
executing code by a data processing system to perform operations comprising:
accessing:
i. online registration information from a set of first job applicants;
ii. a personal profile of each job applicant in the set of job applicants;
iii. associations to online job applications on one or more third party websites that displayed personal profiles of the job applicants; and
iv. data entries by the job applicants for selected data fields of the personal profile;
generating and storing a set of data points associating the selected data fields of the personal profile to the identified data fields of the online job application;
utilizing the set of stored data points to generate a model of the online job application, the model including nodes correlating data fields of the personal profile to the identified data fields of the online job application;
receiving an online registration of a second job applicant;
responsive to the online registration of a second job applicant, obtaining a second personal profile of the second job applicant;
receiving a second online query from the second job applicant;
responsive to the second online query from the second job applicant, providing association to the online job application on the third party website; and
utilizing the model of the online job application, providing recommended data fields of the second personal profile to the second job applicant for completing identified data fields of the online job application.

2. The method of claim 1 wherein the operations further comprise:
utilizing a software tool to identify a variable associated with each data field of the online job application on the third party website; and including the associated variable with each data field in the generated set of data points.

3. The method of claim 1 wherein the operations further comprise:
receiving the online registration of a job applicant;
responsive to the online registration of a job applicant, obtaining the personal profile of the job applicant;
receiving an online query from the job applicant;
responsive to the online query from the job applicant, providing association to an online job application on the third party website that displayed the personal profile of the job applicant;
receiving job applicant selections of data from the selected data fields of the personal profile; and
responsive to the job applicant selecting data from selected data fields of the personal profile to fill identified data fields of the online job application, generating and storing the set of data points associating the selected data fields of the personal profile to the identified data fields of the online job application.

4. The method of claim 3 wherein the operations further comprise:
aggregating, based on the online job application association, multiple sets of data points associating the selected data fields of the personal profile to the identified data fields of the online job application.

5. The method of claim 3 wherein the operations further comprise:
determining a topology of each online job application; and aggregating, based on the online job application association, multiple sets of data points associating the selected data fields of the personal profile to the identified data fields of the online job application.

6. The method of claim 3 wherein the operations further comprise:
archiving selected data points from the set of data points.

7. The method of claim 6 wherein the operations further comprise:
reviewing multiple sets of data points to identify associations between data points; and upon meeting a predetermined threshold of correlation, generating a set of nodes associating the selected data fields of the personal profile to the identified data fields and associated variables of the online job application.

8. The method of claim 3 wherein the operations further comprise:
storing the generated set of nodes as a model of the online job application, the model including nodes correlating data fields of the personal profile to the data fields of the online job application.

9. A job application management system comprising:
one or more processors; and
a memory, coupled to the one or more processors, having code stored therein for modeling and enabling a data processing system to automatically complete an online job application on a third party website, wherein the code is executable by the one or more processors to cause the one or more processors to perform operations comprising:
accessing:
i. online registration information from a set of first job applicants;
ii. a personal profile of each job applicant in the set of job applicants;
iii. associations to online job applications on one or more third party websites that displayed personal profiles of the job applicants; and
iv. data entries by the job applicants for selected data fields of the personal profile;
generating and storing a set of data points associating the selected data fields of the personal profile to the identified data fields of the online job application;
utilizing the set of stored data points to generate a model of the online job application, the model including nodes correlating data fields of the personal profile to the identified data fields of the online job application;
receiving an online registration of a second job applicant;
responsive to the online registration of a second job applicant, obtaining a second personal profile of the second job applicant;
receiving a second online query from the second job applicant;
responsive to the second online query from the second job applicant, providing association to the online job application on the third party website; and
utilizing the model of the online job application, providing recommended data fields of the second personal profile to the second job applicant for completing identified data fields of the online job application.

10. The job application management system of claim 9 wherein the operations further comprise:
utilizing a software tool to identify a variable associated with each data field of the online job application on the third party website; and including the associated variable with each data field in the generated set of data points.

11. The job application management system of claim 10 wherein the operations further comprise:
receiving the online registration of a job applicant;
responsive to the online registration of a job applicant, obtaining the personal profile of the job applicant;
receiving an online query from the job applicant;
responsive to the online query from the job applicant, providing association to an online job application on the third party website that displayed the personal profile of the job applicant;
receiving job applicant selections of data from the selected data fields of the personal profile; and
responsive to the job applicant selecting data from selected data fields of the personal profile to fill identified data fields of the online job application, generating and storing the set of data points associating the selected data fields of the personal profile to the identified data fields of the online job application.

12. The job application management system of claim 11 wherein the operations further comprise:
aggregating, based on the online job application association, multiple sets of data points associating the selected data fields of the personal profile to the identified data fields of the online job application.

13. The job application management system of claim 11 wherein the operations further comprise:
determining a topology of each online job application; and aggregating, based on the online job application association, multiple sets of data points associating the selected data fields of the personal profile to the identified data fields of the online job application.

14. The job application management system of claim 11 wherein the operations further comprise:
archiving selected data points from the set of data points.

15. The job application management system of claim 14 wherein the operations further comprise:
reviewing multiple sets of data points to identify associations between data points; and upon meeting a predetermined threshold of correlation, generating a set of nodes associating the selected data fields of the personal profile to the identified data fields and associated variables of the online job application.

16. The job application management system of claim 15 wherein the operations further comprise:
storing the generated set of nodes as a model of the online job application, the model including nodes correlating data fields of the personal profile to the data fields of the online job application.

17. A non-transitory, computer readable medium having code stored therein for modeling and enabling a data processing system to automatically complete an online job application on a third party website, wherein the code is executable by one or more processors to cause the one or more processors to perform operations comprising:
accessing:
i. online registration information from a set of first job applicants;
ii. a personal profile of each job applicant in the set of job applicants;
iii. associations to online job applications on one or more third party websites that displayed personal profiles of the job applicants; and
iv. data entries by the job applicants for selected data fields of the personal profile;
generating and storing a set of data points associating the selected data fields of the personal profile to the identified data fields of the online job application;
utilizing the set of stored data points to generate a model of the online job application, the model including nodes correlating data fields of the personal profile to the identified data fields of the online job application;
receiving an online registration of a second job applicant;
responsive to the online registration of a second job applicant, obtaining a second personal profile of the second job applicant;
receiving a second online query from the second job applicant;
responsive to the second online query from the second job applicant, providing association to the online job application on the third party website; and
utilizing the model of the online job application, providing recommended data fields of the second personal profile to the second job applicant for completing identified data fields of the online job application.

18. The non-transitory, computer readable medium of claim 17 wherein the operations further comprise:
utilizing a software tool to identify a variable associated with each data field of the online job application on the third party website; and including the associated variable with each data field in the generated set of data points.

19. The non-transitory, computer readable medium of claim 17 wherein the operations further comprise:
receiving the online registration of a job applicant;
responsive to the online registration of a job applicant, obtaining the personal profile of the job applicant;
receiving an online query from the job applicant;
responsive to the online query from the job applicant, providing association to an online job application on the third party website that displayed the personal profile of the job applicant;
receiving job applicant selections of data from the selected data fields of the personal profile; and
responsive to the job applicant selecting data from selected data fields of the personal profile to fill identified data fields of the online job application, generating and storing the set of data points associating the selected data fields of the personal profile to the identified data fields of the online job application.

20. The non-transitory, computer readable medium of claim 19 wherein the operations further comprise:
aggregating, based on the online job application association, multiple sets of data points associating the selected data fields of the personal profile to the identified data fields of the online job application.

21. The non-transitory, computer readable medium of claim 19 wherein the operations further comprise:
determining a topology of each online job application; and aggregating, based on the online job application association, multiple sets of data points associating the selected data fields of the personal profile to the identified data fields of the online job application.

22. The non-transitory, computer readable medium of claim 19 wherein the operations further comprise:
archiving selected data points from the set of data points.

23. The non-transitory, computer readable medium of claim 22 wherein the operations further comprise:
reviewing multiple sets of data points to identify associations between data points; and upon meeting a predetermined threshold of correlation, generating a set of nodes associating the selected data fields of the personal profile to the identified data fields and associated variables of the online job application.

24. The non-transitory, computer readable medium of claim 23 wherein the operations further comprise:
storing the generated set of nodes as a model of the online job application, the model including nodes correlating data fields of the personal profile to the data fields of the online job application.
